(19) United States
(12) Patent Application Publication
(10) Pub. No.: US 2025/0297043 A1
(43) Pub. Date: Sep. 25, 2025

(54) Low Cost Processes of In-Situ MAO Supportation and the Derived Finished Polyolefin Catalysts

(71) Applicant: ExxonMobil Chemical Patents Inc., Baytown, TX (US)

(72) Inventor: Lubin Luo, Houston, TX (US)

(21) Appl. No.: 18/876,390

(22) PCT Filed: May 23, 2023
(86) PCT No.: PCT/US2023/067329

§ 371 Date: Dec. 18, 2024

Related U.S. Application Data
(60) Provisional application No. 63/355,250, filed on Jun. 24, 2022.

(51) Int. Cl. C08F 210/02

(52) U.S. Cl. CPC C08F 210/02; C08F 2420/10

(57) ABSTRACT

The present disclosure provides methods for preparing a catalyst system comprising contacting in an organic solvent at a temperature of from less than −6° C. to −60° C. at least one support material having absorbed water and trimethylaluminum (TMA) to form a supported MAO (catalyst precursor) in-situ and contacting the supported MAO with at least one catalyst precursor compound having a Group 3 through Group 12 metal atom or lanthanide metal atom, wherein the TMA to water ratio and the in-situ sMAO formation temperature are so controlled that the supemate after the in-situ supported MAO formation with optional heating or after the finished catalyst formation contains no NMR detectable TMA or no more than 500 ppm TMA.

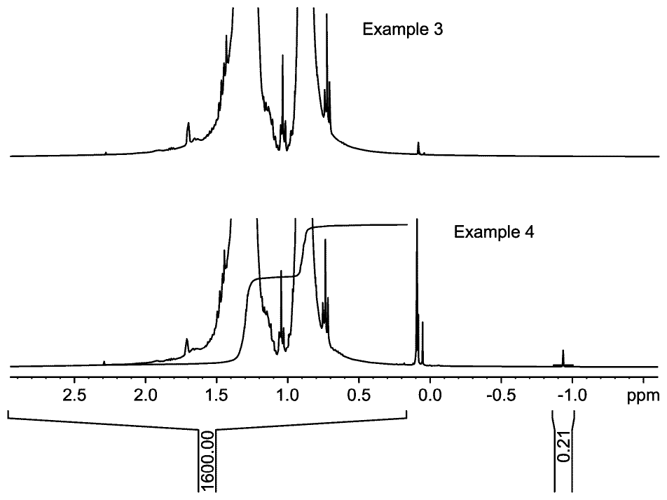

### CROSS REFERENCE TO RELATED APPLICATIONS

This application claims the benefit of and priority to U.S. Provisional Application No. 63/355,250 filed Jun. 24, 2022, the disclosure of which is incorporated herein by reference.

### FIELD

The present disclosure relates to methods of producing the polyolefin catalyst systems with improved catalyst operability in either slurry or gas phase polyolefin reactors and reduced cost for the production of the catalyst systems.

### BACKGROUND

Polyolefins are widely used commercially because of their robust physical properties. For example, various types of polyethylenes, including high density, low density, and linear low density polyethylenes, are some of the most commercially useful. Polyolefins are typically prepared with a catalyst (mixed with one or more other components to form a catalyst system) which promotes polymerization of olefin monomers in a reactor, such as a gas phase reactor.

Methyalumoxane, or MAO, is the most popular activator supported on silica to activate a single site catalyst precursor, e.g., a metallocene, to form an active solid catalyst used in a commercial gas phase reactor to produce single-site polyolefin resins.

Commercial MAO is commonly sold as a toluene solution because an aromatic solvent can dissolve MAO to form a homogeneous solution without causing any issue observed with other solvents, e.g., a donor containing solvent (e.g., an ether or a THF) deactivates MAO, an active proton containing solvent (e.g., an alcohol) reacts and destroys MAO, and an aliphatic solvent (e.g., hexane) precipitates MAO. However, the MAO toluene solution is thermally unstable and requires to be stored in a cold environment, e.g., at −20° C. to −30° C., to reduce the gelation process typically observed for this kinetic product in order to provide a more homogeneous (i.e., less gellated) MAO solution in a given period of time, e.g., about 3 months. The MAO molecules start to dimerize/oligomerize to eventually form insoluble gel right after they are made even under cooling. An MAO product with a different age, e.g., 1 month vs. 3 months storage at −20° C., can thus have a significantly different molecule composition, with the fresher one having more MAO molecule population with smaller sizes vs. the longer aging one having less MAO molecule population with larger sizes due to the gelation process. It is highly desired to obtain MAO molecules with a lower gel content therefore to more evenly distribute in the pores of the catalyst support material, e.g., silica, to obtain a catalyst with good performance including good productivity and good operability. Furthermore, polyolefin products are often used as plastic packaging for sensitive products, and the amount of non-polyolefin compounds, such as toluene, present in the polyolefin products should be minimized.

It was demonstrated in U.S. Pat. No. 11,161,922 that MAO can be made in-situ on a support, e.g., silica, by the addition of water treated silica into a cold trimethylaluminum (TMA) solution. It has been found that, once MAO molecules are supported (anchored on pore surface), their gelation process is almost completely blocked due to the immobility of the MAO molecules to meet and dimerize. The in-situ supported MAO (sMAO) therefore doesn't need to be stored at a cold temperature and the resulting sMAO can maintain the ratio of large to small molecules and the total MAO molecule population to give a more consistent performance against storage period. The formation of in-situ sMAO doesn't require an aromatic solvent.

It has been experimentally verified that a fresh made active MAO composition from the reaction of TMA with cooling includes the coordinated TMA (TMA^{c}), e.g., (Al₄O₃Me₆)₄(TMA^{c})ₙ (n=1 or 2) (Sinn, et al, “Formation, Structure, and Mechanism of Oligomeric Methylaluminoxane”, in Kaminsky (ed.), Metalorg. Cat. for Synth. & Polym., Springer-Verlag, 1999, pp 105). The TMA^{c} in MAO has been identified as the major active site in MAO to serve as the precursor of AlMe₂⁺, the actual active species (Luo, Jain, and Harlan, ACS Annual Meeting, Conference Abstracts PMSE 126 and INOR 1169, April 2-6, 2017). References of interest include: U.S. Pat. Nos. 8,354,485; 9,090,720; 7,910,764; 8,575,284; 8,575,284; 5,006,500; 4,937,217; U.S. Patent Publication No. 2016/0355618; and WO 2016/170017. To maximize TMA^{c} on in-situ sMAO, the TMA:water ratio at least 1.5:1 based on the Al:0 ratio in MAO formula (Al₄O₃Me₆)₄(TMA^{c})₂ is used (U.S. Pat. No. 11,161,922). Such a ratio usually results in residual free TMA (TMA^{E}) in the supernate due to the equilibrium of TMA^{f} with TMA^{c} on MAO (Eq 1).

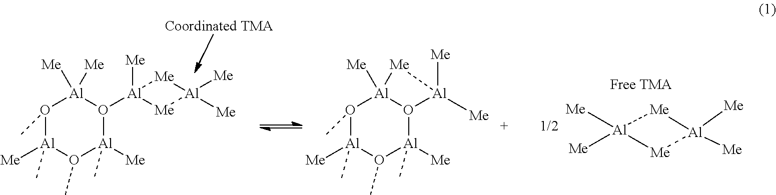

The residual TMA^{f} in supernate requires to be removed by filtration and wash with a solvent to avoid the polymerization reactor fouling presumably due to the reaction of TMA^{f} with the neutral catalyst precursor such as a neutral metallocene existed in the equilibrium activation process with sMAO to form the non-supported soluble low activity species (Eq 2):

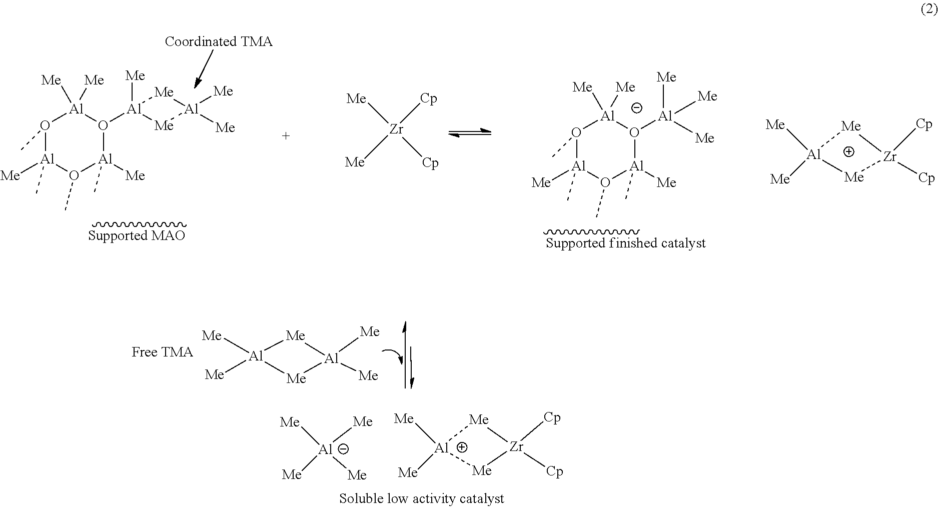

### SUMMARY

Exemplary embodiments described herein relate to methods for preparing in-situ supported MAO comprising contacting in an organic solvent at a temperature of from −6° C. to −60° C. at least one support material having absorbed water and TMA with the controlled ratio of TMA to water therefore to obtain a supernate free of or low in free TMA. This eliminates the need of filtration and wash steps to simplify both the finished catalysts production equipment/facilities and the solid finished catalyst isolation and drying processes, such as with simple heating and/or vacuum drying. This also allows the solvent to be either directly reused in a continuing catalyst production process or disposed normally without further treatment. The obtained finished catalysts also display excellent reactor operability under both gas-phase and slurry-phase polymerization conditions.

Exemplary embodiments described herein relate to methods for preparing a catalyst system comprising contacting in an organic solvent at a temperature of from less than −6° C. to −60° C. at least one support material having absorbed water and TMA in a controlled TMA to water ratio to form a supported MAO in-situ and contacting the supported MAO with at least one catalyst precursor compound having a Group 3 through Group 12 metal atom or lanthanide metal atom. The supported MAO may be heated prior to contact with the catalyst compound.

Exemplary embodiments described herein relate to a catalyst system including a catalyst compound having a Group 3 through Group 12 metal atom or lanthanide metal atom. The catalyst system further includes in-situ supported MAO and has no detectable amount of aromatic solvent when only aliphatic solvents are in use.

### BRIEF DESCRIPTION OF THE DRAWINGS

The Figure provides a spectrum comparing TMA content in Examples 3 and 4.

### DETAILED DESCRIPTION

For catalyst preparation facilities without the filtration and wash capability, the free TMA cannot be removed; and even with filtration and wash capability, residual free TMA in the supernate also complicates the waste solvent disposal, e.g., needing a procedure to deactivate the free TMA before a normal disposal process.

Therefore, there is a need to obtain the supported finished catalyst without free TMA in the supernate, or at least low in concentration, not to cause any significant polymerization reactor operation issue and to allow the direct reuse of the solvent as-is.

The present disclosure relates to catalyst systems preparation methods to obtain the supemate free of or low in TMA to enable simple catalyst preparation facilities without filtration and wash capability to produce the dried finished catalyst systems with good polymerization reactor operability and the direct reuse of the solvent used for the in-situ supported MAO formation and/or the derived finished catalyst formation. Embodiments of the present disclosure include methods for preparing an in-situ supported MAO including contacting in an organic solvent at a temperature in the range of −6° C. to −60° C. at least one support material having absorbed water and TMA with a controlled charged Al:water ratio to obtain the supernate free of or low in free TMA. The supported MAO is formed in-situ when TMA reacts with the absorbed water on the silica, wherein TMA and the absorbed water on the support are controlled in a different ratio and the in-situ supported MAO formation temperature are controlled in a different range based on the absorbed water content, provided that:
a. for a support containing absorbed water 6.5 (mmol/g support) or less, the charged TMA:water ratio is controlled in the range of between 1.31:1 and 1.25:1 and the in-situ supported MAO formation temperature is controlled at between −8° C. and −60° C.; or
b. for a support containing absorbed water 5.0 (mmol/g support) or less, the charged TMA:water ratio is controlled in the range of between 1.42:1 and 1.25:1 and the in-situ supported MAO formation temperature is controlled at between −8° C. to −60° C.; or
c. for a support containing absorbed water 7.0-10.0 (mmol/g support), the charged TMA:water ratio is controlled in the range of between 1.20:1 and 1.15:1 and the in-situ sMAO formation temperature is controlled at between −12° C. and −60° C.

Alternatively, to obtain the supernate free of or low in free TMA, the charged TMA to water ratio is controlled in between 1.80:1 to 1.42:1 and the in-situ supported MAO formation temperature is controlled in between −6° C. to −60° C., and then remove free TMA from the supernate, after the in-situ supported MAO formation or after the finished catalyst formation, by adding a second support containing hydroxyl groups to the supemate, wherein the support containing hydroxyl groups can be a support containing absorbed water or a support containing pore surface hydroxyl groups, such as silica calcined at 150° C., 200° C., 400° C., or higher.

The present disclosure also includes methods for preparing catalyst systems comprising a heating step for the in-situ supported MAO prior to contact with a catalyst precursor compound. The catalyst precursor compound has a Group 3 through Group 12 metal atom or lanthanide metal atom. The catalyst precursor compound can be a metallocene catalyst compound comprising a Group 4 metal. Any organic solvent can be used, including aliphatic solvents to obtain aromatic free (undetectable) finished catalyst systems.

In at least one embodiment, the present disclosure relates to a continuous process for preparing in-situ supported MAO comprising contacting in an organic solvent at a temperature of from −6° C. to −60° C. at least one support material having absorbed water and TMA to produce the in-situ supported MAO and the supported MAO derived finished catalyst, wherein the absorbed water on the support and TMA are controlled to have:
a. for a support containing absorbed water 6.5 (mmol/g support) or less, the charged TMA:water ratio in the range of between 1.31:1 and 1.25:1 and the in-situ supported MAO formation temperature is controlled at between −8° C. and −60° C.; or
b. for a support containing absorbed water 5.0 (mmol/g support) or less, the charged TMA:water ratio in the range of between 1.42:1 and 1.25:1 and the in-situ supported MAO formation temperature is controlled at between −8° C. to −60° C.; or
c. for a support containing absorbed water 7.0-10.0 (mmol/g support), the charged TMA:water ratio in the range of between 1.20:1 and 1.15:1 and the in-situ sMAO formation temperature is controlled at between −12° C. and −60° C.; and
separating the in-situ supported MAO or the derived finished catalyst from the organic solvent, i.e., the supernate, which can be reused as the solvent without further treatment.

The present disclosure also relates to a method of polymerizing olefins to produce a polyolefin composition comprising contacting at least one olefin with a catalyst system prepared as described herein and obtaining a polyolefin having no detectable aromatic hydrocarbon solvent by using one or more aliphatic solvents, e.g., pentane, isohexane, and/or heptane, in the in-situ supported MAO formation and the derived finished catalyst preparation processes.

The present disclosure also relates to a method for preparing a catalyst system comprising contacting in at least one organic solvent at a temperature of from less than −8° C. to −60° C. at least one support material having absorbed water and TMA to form a supported MAO, wherein the absorbed water on the support and TMA are controlled to have:
a. for a support containing absorbed water 6.5 (mmol/g support) or less, the charged TMA:water ratio in the range of between 1.31:1 and 1.25:1 and the in-situ supported MAO formation temperature is controlled at between −8° C. and −60° C.; or
b. for a support containing absorbed water 5.0 (mmol/g support) or less, the charged TMA:water ratio in the range of between 1.42:1 and 1.25:1 and the in-situ supported MAO formation temperature is controlled at between −8° C. to −60° C.; or
c. for a support containing absorbed water 7.0-10.0 (mmol/g support), the charged TMA:water ratio in the range of between 1.20:1 and 1.15:1 and the in-situ sMAO formation temperature is controlled at between −12° C. and −60° C.; and
heating the supported MAO to at least 50° C. up to 140° C., and then contacting at least one catalyst precursor compound to form the finished catalyst comprising a Group 3 through Group 12 metal atom or lanthanide metal atom.

The present disclosure also relates to a method for preparing a catalyst system comprising contacting in at least one organic solvent at a temperature of from less than −8° C. to −60° C. at least one support material having absorbed water and TMA to form an in-situ supported MAO, wherein the absorbed water on the support and TMA are controlled to have:
a. for a support containing absorbed water 6.5 (mmol/g support) or less, the charged TMA:water ratio in the range of between 1.31:1 and 1.25:1 and the in-situ supported MAO formation temperature is controlled at between −8° C. and −60° C.; or
b. for a support containing absorbed water 5.0 (mmol/g support) or less, the charged TMA:water ratio in the range of between 1.42:1 and 1.25:1 and the in-situ supported MAO formation temperature is controlled at between −8° C. to −60° C.; or
c. for a support containing absorbed water 7.0-10.0 (mmol/g support), the charged TMA:water ratio in the range of between 1.20:1 and 1.15:1 and the in-situ sMAO formation temperature is controlled at between −12° C. and −60° C.; and
contacting the supported MAO with at least one catalyst precursor compound comprising a Group 3 through Group 12 metal atom or lanthanide metal atom to form a supported catalyst system and heating the supported catalyst system to at least 50° C. up to 100° C.

The present disclosure also relates to a process of making an in-situ supported MAO in at least one organic solvent comprising adding at least one support material having absorbed water as solid or slurry form to a TMA organic solvent solution at a temperature in the range of −8° C. to −60° C., wherein the absorbed water on the support and TMA are controlled to have:
a. for a support containing absorbed water 6.5 (mmol/g support) or less, the charged TMA:water ratio in the range of between 1.31:1 and 1.25:1 and the in-situ supported MAO formation temperature is controlled at between −8° C. and −60° C.; or
b. for a support containing absorbed water 5.0 (mmol/g support) or less, the charged TMA:water ratio in the range of between 1.42:1 and 1.25:1 and the in-situ supported MAO formation temperature is controlled at between −8° C. to −60° C.; or
c. for a support containing absorbed water 7.0-10.0 (mmol/g support), the charged TMA:water ratio in the range of between 1.20:1 and 1.15:1 and the in-situ sMAO formation temperature is controlled at between −12° C. and −60° C.

The present disclosure also relates to a process of making an in-situ supported MAO and the derived finished catalyst free of aromatic solvent comprising adding at least one support material having absorbed water, as solid or as an aliphatic solvent slurry, to TMA aliphatic solvent solution at a temperature in the range of −8° C. to −60° C., wherein the absorbed water on the support and TMA are controlled to have:
a. for a support containing absorbed water 6.5 (mmol/g support) or less, the charged TMA:water ratio in the range of between 1.31:1 and 1.25:1 and the in-situ supported MAO formation temperature is controlled at between −8° C. and −60° C.; or
b. for a support containing absorbed water 5.0 (mmol/g support) or less, the charged TMA:water ratio in the range of between 1.42:1 and 1.25:1 and the in-situ supported MAO formation temperature is controlled at between −8° C. to −60° C.; or
c. for a support containing absorbed water 7.0-10.0 (mmol/g support), the charged TMA:water ratio in the range of between 1.20:1 and 1.15:1 and the in-situ sMAO formation temperature is controlled at between −12° C. and −60° C.

The present disclosure also relates to a process of making an in-situ supported MAO and the derived finished catalyst free of aromatic solvent comprising adding at least one support material having absorbed water, as solid or as an aliphatic solvent slurry, to TMA aliphatic solvent solution at a temperature in the range of −6° C. to −60° C., wherein charged TMA to water ratio is controlled in between 1.80:1 to 1.42:1 and then remove free TMA from the supernate, after the in-situ supported MAO formation or after the finished catalyst formation, by adding a second support containing hydroxyl groups to the supernate, wherein the support containing hydroxyl groups can be a support containing absorbed water or a support containing pore surface hydroxyl groups, such as silica calcined at 150° C., 200° C., 400° C., or higher.

The present disclosure also relates to any process described herein where the TMA solution concentration is 0.1 wt % to 40 wt %, preferably is 1.0 wt % to 20 wt %.

The present disclosure also relates to processes where the process is continuous and comprises isolating the solid supported MAO or the derived finished catalyst product and recycling the organic solvent without further treatment.

The present disclosure also relates to any process described herein where the in-situ formed supported MAO composition is further heat-treated at a temperature selected from 50° C. to 140° C. for 0.5 to 24 hours prior to contact with the catalyst precursor compound.

Embodiments of the present disclosure also include catalyst systems including a Group 4 metal catalyst compound selected from a metallocene catalyst precursor compound, a half-metallocene catalyst precursor compound, or a post-metallocene catalyst precursor compound.

Use of an aliphatic solvent such as isohexane instead of an aromatic solvent such as toluene provides a catalyst system (and polyolefin products) with no detectable amount of aromatic hydrocarbon solvent content while maintaining activity similar to that of catalyst systems prepared with pre-formed MAO in a required aromatic solvent, such as the Grace commercial MAO products, for example, 30% MAO in the toluene solution.

Eliminating aromatic hydrocarbon solvent in the catalyst system provides polyolefin products having no detectable aromatic hydrocarbon solvent (preferably no detectable toluene), as determined by gas phase chromatography as described in the Experimental section below. The polyolefin products may be used as plastic materials for use in toluene-free materials such as in packaging for food products, automotive interior materials, and medical devices. Furthermore, many saturated hydrocarbons have lower boiling points than aromatic hydrocarbons, such as pentane (36.1° C.) vs. toluene (110° C.), which makes the saturated hydrocarbons easier to remove from the polyolefin products to reduce the energy consumption. The in-situ MAO supportation technology also eliminates the solution MAO production plant that requires to store and transport MAO products between the MAO plant location and the user location under cold condition 24/7 before use, which further reduces the energy consumption. The MAO gel cleaning plant for routing gelation in both the MAO formation reactors and the storage containers is also eliminated to avoid waste water going into the river or land.

For purposes of the present disclosure, “supernate” means the inert organic solvent used for the dilution of the starting materials and remains as the same solvent with the insoluble products of either the in-situ supported MAO or the derived catalyst system in the reactor after the related reaction is completed, including some soluble inert byproduct substances formed from the reaction of water or the support material with TMA, e.g., CH₄ from the reaction of TMA with water, siloxanes from the reaction of TMA with the support surface silicon and oxygen containing species, or dissolved from the reactor facilities, e.g., oil or grease. “Supernate free of TMA” means that TMA is NMR undetectable in the supernate. “Supernate low in hydrocarbyl aluminum compound” means that TMA is 600 ppm or less determined by NMR in the supernate. For purposes of the present disclosure, “detectable aromatic hydrocarbon solvent” means 0.1 mg/m² or more as determined by gas phase chromatography. For purposes of the present disclosure, “detectable toluene” means 0.1 mg/m² or more as determined by gas phase chromatography.

As used herein, in-situ supported MAO and in-situ sMAO have the same meaning, as well as coordinated TMA=TMA^{c}, and free TMA=TMA^{f}. Metallocenes, single-site catalysts, or transition metal compounds are all catalyst precursor compounds, meaning they need an activator to become activated before they can polymerize olefins, and can be used exchangeably.

As used herein, the term “saturated hydrocarbon” includes hydrocarbons that contain zero carbon-carbon double bonds. The saturated hydrocarbon can be a linear or cyclic hydrocarbon. The saturated hydrocarbon can be a C₃-C₄₀ hydrocarbon, such as a C₃-C₇ hydrocarbon. In at least one embodiment, the C₃-C₄₀ hydrocarbon is propane, isobutane, isopentane, cyclohexane, isohexane, hexane, heptane, octane, or mixtures thereof.

In at least one embodiment, a method of polymerizing olefins to produce a polyolefin composition includes contacting at least one olefin with a catalyst system of the present disclosure and obtaining a polyolefin having no detectable aromatic hydrocarbon solvent. Polymerization can be conducted at a temperature of from about 0° C. to about 200° C., at a pressure of from about 0.35 MPa to about 10 MPa, and at a time up to about 300 minutes. The at least one olefin can be C₂ to C₄₀ olefin, preferably C₂ to C₂₀ alpha-olefin preferably ethylene, propylene, butene, pentene, hexene, heptene, octene, nonene, decene, undecene, dodecene, or mixtures thereof.

For purposes of the present disclosure, the numbering scheme for the Periodic Table Groups is used as described in Chemical and Engineering News, v.63(5), pg. 27 (1985). Therefore, a “Group 4 metal” is an element from group 4 of the Periodic Table, e.g., Hf, Ti, or Zr.

“Catalyst productivity” is a measure of how many grams of polymer (P) are produced using a polymerization catalyst comprising W g of catalyst (cat), over a period of time of T hours; and may be expressed by the following formula: P/(T×W) and expressed in units of gPgcat⁻¹hr⁻¹. Conversion is the amount of monomer that is converted to polymer product, and is reported as mol % and is calculated based on the polymer yield (weight) and the amount of monomer fed into the reactor. Catalyst activity is a measure of the level of activity of the catalyst and is reported as the mass of product polymer (P) produced per mass of supported catalyst (cat) (gP/g supported cat). In an at least one embodiment, the activity of the catalyst is at least 800 gpolymer/gsupported catalyst/hour, such as about 1,000 or more gpolymer/gsupported catalyst/hour, such as about 2,000 or more gpolymer/gsupported catalyst/hour, such as about 3,000 or more gpolymer/gsupported catalyst/hour, such as about 4,000 or more gpolymer/gsupported catalyst/hour, such as about 5,000 or more gpolymer/gsupported catalyst/hour.

An “olefin,” alternatively referred to as “alkene,” is a linear, branched, or cyclic compound of carbon and hydrogen having at least one double bond. When a polymer or copolymer is referred to as comprising an olefin, the olefin present in such polymer or copolymer is the polymerized form of the olefin. For example, when a copolymer is said to have an ethylene content of 35 wt % to 55 wt %, it is understood that the monomer (“mer”) unit in the copolymer is derived from ethylene in the polymerization reaction and the derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. “Different” as used to refer to mer units indicates that the mer units differ from each other by at least one atom or are different isomerically. Accordingly, the definition of “copolymer,” as used herein, includes terpolymers and the like. An oligomer is typically a polymer having a low molecular weight, such an Mn of less than 25,000 g/mol, or less than 2,500 g/mol, or a low number of mer units, such as 75 mer units or less or 50 mer units or less. An “ethylene polymer” or “ethylene copolymer” is a polymer or copolymer comprising at least 50 mole % ethylene derived units, a “propylene polymer” or “propylene copolymer” is a polymer or copolymer comprising at least 50 mole % propylene derived units, and so on.

A “catalyst system” is a combination of at least one catalyst compound and a support material. The catalyst system may have at least one activator and/or at least one co-activator. When catalyst systems are described as comprising neutral stable forms of the components, it is well understood that the ionic form of the component is the form that reacts with the monomers to produce polymers. For purposes of the present disclosure, “catalyst system” includes both neutral and ionic forms of the components of a catalyst system.

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are g/mol.

In the present disclosure, the catalyst may be described as a catalyst precursor, a pre-catalyst compound, catalyst compound or a transition metal compound, and these terms are used interchangeably. An “anionic ligand” is a negatively charged ligand which donates one or more pairs of electrons to a metal ion. A “neutral donor ligand” is a neutrally charged ligand which donates one or more pairs of electrons to a metal ion.

For purposes of the present disclosure in relation to catalyst compounds, the term “substituted” means that a hydrogen group has been replaced with a hydrocarbyl group, a heteroatom, or a heteroatom containing group. For example, methylcyclopentadiene (MeCp) is a Cp group substituted with a methyl group.

The present disclosure describes transition metal complexes. The term complex is used to describe molecules in which an ancillary ligand is coordinated to a central transition metal atom. The ligand is stably bonded to the transition metal so as to maintain its influence during use of the catalyst, such as polymerization. The ligand may be coordinated to the transition metal by covalent bond and/or electron donation coordination or intermediate bonds. The transition metal complexes are generally subjected to activation to perform their polymerization function using an activator which is believed to create a cation as a result of the removal of an anionic group, often referred to as a leaving group, from the transition metal.

When used in the present disclosure, the following abbreviations mean: Me is methyl, Ph is phenyl, Et is ethyl, Pr is propyl, iPr is isopropyl, n-Pr is normal propyl, cPr is cyclopropyl, Bu is butyl, iBu is isobutyl, tBu is tertiary butyl, p-tBu is para-tertiary butyl, nBu is normal butyl, sBu is sec-butyl, TMS is trimethylsilyl, TIBAL is triisobutylaluminum, TNOAL is tri(n-octyl)aluminum, MAO is methylalumoxane, sMAO is supported methylalumoxane, Bn is benzyl (i.e., CH₂Ph), THF (also referred to as thf) is tetrahydrofuran, RT is room temperature (and is 23° C. unless otherwise indicated), tol is toluene, EtOAc is ethyl acetate, and Cy is cyclohexyl.

The terms “hydrocarbyl radical,” “hydrocarbyl,” “hydrocarbyl group,” “alkyl radical,” and “alkyl” are used interchangeably throughout this disclosure. Likewise, the terms “group”, “radical”, and “substituent” are also used interchangeably in this disclosure. For purposes of this disclosure, “hydrocarbyl radical” is defined to be C₁-C₁₀₀ radicals, that may be linear, branched, or cyclic, and when cyclic, aromatic or non-aromatic. Examples of such radicals include, but are not limited to, methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like including their substituted analogues. Substituted hydrocarbyl radicals are radicals in which at least one hydrogen atom of the hydrocarbyl radical has been substituted with at least a non-hydrogen group, such as halogen (such as Br, Cl, F or I) or at least one functional group such as NR*₂, OR*, SeR*, TeR*, PR*₂, AsR*₂, SbR*₂, SR*, BR*₂, SiR*₃, GeR*₃, SnR*₃, PbR*₃, and the like, or where at least one heteroatom has been inserted within a hydrocarbyl ring.

The term “alkenyl” means a straight-chain, branched-chain, or cyclic hydrocarbon radical having one or more carbon-carbon double bonds. These alkenyl radicals may be substituted. Examples of suitable alkenyl radicals include, but are not limited to, ethenyl, propenyl, allyl, 1,4-butadienyl, cyclopropenyl, cyclobutenyl, cyclopentenyl, cyclohexenyl, cycloctenyl and the like including their substituted analogues.

The term “aryl” or “aryl group” means a carbon-containing aromatic ring and the substituted variants thereof, including but not limited to, phenyl, 2-methyl-phenyl, xylyl, 4-bromo-xylyl. Likewise, heteroaryl means an aryl group where a ring carbon atom (or two or three ring carbon atoms) has been replaced with a heteroatom, preferably N, O, or S. As used herein, the term “aromatic” also refers to pseudoaromatic heterocycles which are heterocyclic substituents that have similar properties and structures (nearly planar) to aromatic heterocyclic ligands, but are not by definition aromatic.

“Aromatic” means a hydrocarbyl compound containing a planar unsaturated ring of atoms that is stabilized by interaction of the bonds forming the ring. Such compounds are often six membered rings such as benzene and its derivatives. As used herein, the term “aromatic” also refers to pseudoaromatics which are compounds that have similar properties and structures (nearly planar) to aromatics, but are not by definition aromatic; likewise, the term aromatic also refers to substituted aromatics.

Where isomers of a named alkyl, alkenyl, alkoxide, or aryl group exist (e.g., n-butyl, iso-butyl, sec-butyl, and tert-butyl) reference to one member of the group (e.g., n-butyl) shall expressly disclose the remaining isomers (e.g., iso-butyl, sec-butyl, and tert-butyl) in the family. Likewise, reference to an alkyl, alkenyl, alkoxide, or aryl group without specifying a particular isomer (e.g., butyl) expressly discloses all isomers (e.g., n-butyl, iso-butyl, sec-butyl, and tert-butyl).

The term “ring atom” means an atom that is part of a cyclic ring structure. By this definition, a benzyl group has six ring atoms and tetrahydrofuran has 5 ring atoms. A heterocyclic ring is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom substituted ring.

“Complex” as used herein, is also often referred to as catalyst precursor, precatalyst, catalyst, catalyst compound, transition metal compound, or transition metal complex. These terms are used interchangeably. Activator and cocatalyst are also used interchangeably.

A scavenger is a compound that may be added to a catalyst system to facilitate polymerization by scavenging impurities. Some scavengers may also act as activators and may be referred to as co-activators. A co-activator, that is not a scavenger, may also be used in conjunction with an activator in order to form an active catalyst system. In at least one embodiment, a co-activator can be pre-mixed with the transition metal compound to form an alkylated transition metal compound.

In the present disclosure, a catalyst may be described as a catalyst precursor, a pre-catalyst compound, catalyst compound or a transition metal compound, and these terms are used interchangeably. A polymerization catalyst system is a catalyst system that can polymerize monomers into polymer.

The term “continuous” means a system that operates without interruption or cessation for a period of time. For example, a continuous process to produce a polymer would be one where the reactants are continually introduced into one or more reactors and polymer product is continually withdrawn.

A “bulk polymerization” means a polymerization process in which the monomers and/or comonomers being polymerized are used as a solvent or diluent using little or no inert solvent or diluent. A small fraction of inert solvent might be used as a carrier for catalyst and scavenger. A bulk polymerization system contains less than about 25 wt % of inert solvent or diluent, such as less than about 10 wt %, such as less than about 1 wt %, such as 0 wt %.

The term “a bonding” means two atoms forming a single bond containing two electrons with each atom contributes one electron. The term “coordination bonding” means two atoms forming a single bond containing two electrons with one of the atom contribute all the two electrons, or called electron pair donation bonding.

### Support Materials

In at least one embodiment, a catalyst system comprises a support material capable of absorbing water in an amount of at least 0.5 mmol of water per gram of support material. The support material may be a porous support material, for example, silica, or other inorganic oxides such as aluminas, zeolites, talc, clays, organoclays, or any other organic or inorganic support material containing functional groups including Bronsted sites, e.g., OH groups, Lewis base sites, e.g., electron donor groups such as amines or phosphine groups, or Lewis acid sites, e.g., unsaturated metal centers such as 3 coordinated aluminum sites, and the like, or mixtures thereof.

In at least one embodiment, the support material is an inorganic oxide in a finely divided form. Suitable inorganic oxide materials for use in catalyst systems herein include Groups 2, 4, 13, and 14 metal oxides, such as silica, alumina, and mixtures thereof. Other inorganic oxides that may be employed, either alone or in combination, with the silica, or alumina are magnesia, titania, zirconia, and the like. Other suitable support materials, however, can be employed, for example, finely divided functionalized polyolefins, such as finely divided polyethylene, polypropylene, and polystyrene with functional groups that are able to absorb water, e.g., oxygen or nitrogen containing groups such as —OH, —RC═O, —OR, and —NR₂. Particularly useful supports include magnesia, titania, zirconia, montmorillonite, phyllosilicate, zeolites, talc, clays, silica clay, silicon oxide clay, and the like. Also, combinations of these support materials may be used, for example, silica-chromium, silica-alumina, silica-titania, and the like. In at least one embodiment, the support material is selected from Al₂O₃, ZrO₂, SiO₂, SiO₂/Al₂O₂, silica clay, silicon oxide/clay, or mixtures thereof. The support material may be fluorided.

As used herein, the phrases “fluorided support” and “fluorided support composition” mean a support, desirably particulate and porous, which has been treated with at least one inorganic fluorine containing compound. For example, the fluorided support composition can be a silicon dioxide support wherein a portion of the silica hydroxyl groups has been replaced with fluorine or fluorine containing compounds. Suitable fluorine containing compounds include, but are not limited to, inorganic fluorine containing compounds and/or organic fluorine containing compounds.

Fluorine compounds suitable for providing fluorine for the support may be organic or inorganic fluorine compounds and are desirably inorganic fluorine containing compounds. Such inorganic fluorine containing compounds may be any compound containing a fluorine atom as long as it does not contain a carbon atom. Particularly desirable are inorganic fluorine-containing compounds selected from NH₄BF₄, (NH₄)₂SiF₆, NH₄PF₆, NH₄F, (NH₄)₂TaF₇, NH₄NbF₄, (NH₄)₂GeF₆, (NH₄)₂SmF₆, (NH₄)₂TiF₆, (NH₄)₂ZrF₆, MoF₆, ReF₆, GaF₃, SO₂ClF, F₂, SiF₄, SF₆, ClF₃, ClF₅, BrF₅, IF₇, NF₃, HF, BF₃, NHF₂, NH₄HF₂, and combinations thereof. In at least one embodiment, ammonium hexafluorosilicate and ammonium tetrafluoroborate are used.

In at least one embodiment, the support material comprises a support material treated with an electron-withdrawing anion. The support material can be silica, alumina, silica-alumina, silica-zirconia, alumina-zirconia, aluminum phosphate, heteropolytungstates, titania, magnesia, boria, zinc oxide, mixed oxides thereof, or mixtures thereof; and the electron-withdrawing anion is selected from fluoride, chloride, bromide, phosphate, triflate, bisulfate, sulfate, or any combination thereof.

An electron-withdrawing component can be used to treat the support material. The electron-withdrawing component can be any component that increases the Lewis or Bronsted acidity of the support material upon treatment (as compared to the support material that is not treated with at least one electron-withdrawing anion). In at least one embodiment, the electron-withdrawing component is an electron-withdrawing anion derived from a salt, an acid, or other compound, such as a volatile organic compound, that serves as a source or precursor for that anion. Electron-withdrawing anions can be sulfate, bisulfate, fluoride, chloride, bromide, iodide, fluorosulfate, fluoroborate, phosphate, fluorophosphate, trifluoroacetate, triflate, fluorozirconate, fluorotitanate, phospho-tungstate, or mixtures thereof, or combinations thereof. An electron-withdrawing anion can be fluoride, chloride, bromide, phosphate, triflate, bisulfate, or sulfate, and the like, or any combination thereof, at least one embodiment of this disclosure. In at least one embodiment, the electron-withdrawing anion is sulfate, bisulfate, fluoride, chloride, bromide, iodide, fluorosulfate, fluoroborate, phosphate, fluorophosphate, trifluoroacetate, triflate, fluorozirconate, fluorotitanate, or combinations thereof.

Thus, for example, the support material suitable for use in the catalyst systems of the present disclosure can be one or more of fluorided alumina, chlorided alumina, bromided alumina, sulfated alumina, fluorided silica-alumina, chlorided silica-alumina, bromided silica-alumina, sulfated silica-alumina, fluorided silica-zirconia, chlorided silica-zirconia, bromided silica-zirconia, sulfated silica-zirconia, fluorided silica-titania, fluorided silica-coated alumina, sulfated silica-coated alumina, phosphated silica-coated alumina, and the like, or combinations thereof. In at least one embodiment, the activator-support can be, or can comprise, fluorided alumina, sulfated alumina, fluorided silica-alumina, sulfated silica-alumina, fluorided silica-coated alumina, sulfated silica-coated alumina, phosphated silica-coated alumina, or combinations thereof. In another embodiment, the support material includes alumina treated with hexafluorotitanic acid, silica-coated alumina treated with hexafluorotitanic acid, silica-alumina treated with hexafluorozirconic acid, silica-alumina treated with trifluoroacetic acid, fluorided boria-alumina, silica treated with tetrafluoroboric acid, alumina treated with tetrafluoroboric acid, alumina treated with hexafluorophosphoric acid, or combinations thereof. Further, any of these activator-supports optionally can be treated with a metal ion.

Nonlimiting examples of cations suitable for use in the present disclosure in the salt of the electron-withdrawing anion include ammonium, trialkyl ammonium, tetraalkyl ammonium, tetraalkyl phosphonium, H+, [H(OEt₂)₂]+, [HNR₃]+(R═C₁-C₂₀ hydrocarbyl group, which may be the same or different) or combinations thereof.

Further, combinations of one or more different electron-withdrawing anions, in varying proportions, can be used to tailor the specific acidity of the support material to a desired level. Combinations of electron-withdrawing components can be contacted with the support material simultaneously or individually, and in any order that provides a desired chemically-treated support material acidity. For example, in at least one embodiment, two or more electron-withdrawing anion source compounds in two or more separate contacting steps.

An example of a process by which a chemically-treated support material is prepared is as follows: a selected support material, or combination of support materials, can be contacted with a first electron-withdrawing anion source compound to form a first mixture; such first mixture can be calcined and then contacted with a second electron-withdrawing anion source compound to form a second mixture; the second mixture can then be calcined to form a treated support material. In such a process, the first and second electron-withdrawing anion source compounds can be either the same or different compounds.

The method by which the oxide is contacted with the electron-withdrawing component, typically a salt or an acid of an electron-withdrawing anion, can include, but is not limited to, gelling, co-gelling, impregnation of one compound onto another, and the like, or combinations thereof. Following a contacting method, the contacted mixture of the support material, electron-withdrawing anion, and optional metal ion, can be calcined.

According to another embodiment of the present disclosure, the support material can be treated by a process comprising: (i) contacting a support material with a first electron-withdrawing anion source compound to form a first mixture; (ii) calcining the first mixture to produce a calcined first mixture; (iii) contacting the calcined first mixture with a second electron-withdrawing anion source compound to form a second mixture; and (iv) calcining the second mixture to form the treated support material.

It is preferred that the support material, most preferably an inorganic oxide, has a surface area between about 10 m²/g and about 800 m²/g (optionally 700 m²/g), pore volume between about 0.1 cc/g and about 4.0 cc/g and average particle size between about 5 μm and about 500 m. In at least one embodiment, the surface area of the support material is between about 50 m²/g and about 500 m²/g, pore volume between about 0.5 cc/g and about 3.5 cc/g and average particle size between about 10 μm and about 200 μm. The surface area of the support material may be between about 100 m²/g and about 400 m²/g, pore volume between about 0.8 cc/g and about 3.0 cc/g and average particle size between about 5 μm and about 100 μm. The average pore size of the support material may be between about 10 Å and about 1000 Å, such as between about 50 Å and about 500 Å, such as between about 75 Å and about 350 Å. In at least one embodiment, the support material is an amorphous silica with surface area of 300 to 400 m²/gm and a pore volume of 0.9 to 1.8 cm³/gm. In at least one embodiment, the supported material may optionally be a sub-particle containing silica with average sub-particle size of 0.05 to 5 micron, e.g., from the spray drying of average particle size of 0.05 to 5 micron small particle to form average particle size of 5 to 200 micron large main particles. In at least one embodiment of the supported material, at least 20% of the total pore volume (as defined by BET method) has a pore diameter of 100 angstrom or more. Non-limiting example silicas include Grace Davison's 952, 955, and 948; PQ Corporation (Ecovyst)'s ES70 series, PD17062, PD14024, PD16042, and PD16043; Asahi Glass Chemical (AGC)'s D70-120 Å, DM-H302, DM-M302, DM-M402, DM-L302, DM-L303, DM-L402, and DM-L403; Fuji's P-10/20 or P-10/40; and the like.

The terms “silica” and “support” used in this application are exchangeable to describe the support material, i.e., if silica is used for description, it doesn't mean to limit the support to silica. Other support materials can also be used.

### Supported Materials Having Absorbed Water

In embodiments of the present disclosure, the support material will contain from 0.5 mmol absorbed water per gram of support material to 10 mmol absorbed water per gram of support material. The amount of absorbed water is determined by adding a known amount of water into the hydrocarbon slurry of the support that has been heat treated, e.g., 150° C., 200° C., 400° C., 600° C., or 875° C. to remove pre-absorbed water and allow to agitate in a close container for the added water to evenly distribute in the pore of the support. The amount of water loaded on the support can be quantified/verified by a standard thermogravimetric analysis method, e.g., LOD (loss on drying) at the temperature 300° C. for 4 hours. Most commercial support materials will contain some absorbed water and in some cases the amount of absorbed water may be sufficient. In other cases additional water may be needed; for example, the pre-absorbed amount of water can be first determined with the mentioned LOD method, and additional water is then added to obtain a desired total amount of water absorbed on the support.

In embodiments of the present disclosure, the support material containing from 0.5 mmol absorbed water per gram of support material to 10 mmol absorbed water per gram of support material can be made in a close container as above except no solvent is in use. The solid in the close container can then be placed in an environment to allow the container to be heated evenly, i.e., no cold spot for water to condense on. The heating temperature can be in between 30° C.-100° C., preferably 45° C.-65° C. The heating time is at least 30 minutes, for example, 1 hour, 2 hours, 3 hours, 4 hours, 5 hours, or longer.

Preferably, the support material is silica, alumina, alumina-silica or a derivative thereof.

Preferably, the support material has an average particle size between 1 and 200 microns, an average pore volume of between 0.05 and 5 mL/g, and a surface area between 50 and 800 m²/g.

Preferably, the support material has been treated with one or more of a Bronsted acid, a Lewis acid, a salt and a Lewis base.

Preferably, the support material comprises a silylating agent.

Preferably, the support material comprises a hydrocarbyl aluminum compound.

Preferably, one or more of the support material comprises an electron withdrawing anion.

### Organic Solvents

Suitable organic solvents are materials in which all of the reactants used herein, e.g., the support and the TMA, may or may not be soluble and which are liquid at reaction temperatures. Non-limiting example solvents are non-cyclic alkanes with formula CₙH₍ₙ₊₂₎ where n=3-30, such as propane, isobutene, isopentane, hexane, n-heptane, octane, nonane, decane and the like, and cycloalkanes with formula CₙHₙ where n=5-30, such as cyclopentane, methylcyclopentane, cyclohexane, methylcyclohexane and the like. Aromatic solvents can also be used, e.g., benzene, toluene, and xylenes, but aliphatic solvents are more preferred because MAO solubility in an aromatic solvent such as toluene may cause the MAO to dissolve in the supemate that requires to be removed, e.g., through a filtration step, to avoid reactor fouling and to reuse the solvent.

### TMA

Although TMA are exclusively used for in-situ supported MAO formation. A portion of other alkylaluminum compounds such as a trialkylaluminum compound or a heteroatom substituted alkylaluminum compound may be present, e.g., 50 mol % or less based on total Al. The alkyl substituents are alkyl groups of up to 10 carbon atoms, such as octyl, isobutyl, ethyl or methyl can be present as a minor component. Thus, suitable trialkylaluminum compounds include trimethylaluminum, triethylaluminum, tripropylalumiuum, tri-n-butylaluminum, tri-isobutyl-aluminum, tri(2-methylpentyl)aluminum, trihexylaluminum, tri-n-octylaluminum, tri-n-decylaluminum, and any mixed alkylaluminum compounds such as AlHⁱBu₂, AlEt₂ⁱBu, AlMe₂Oct, and the like. Preferred hydrocarbyl aluminum compounds are trimethylaluminum and tri-n-octylaluminum. Thus, suitable heteroatom substituted alkylaluminum compounds include but are not limited to AlR₂F, AlRF₂, AlR₂(OC₆F₅), AlR₂(OC₆F₅), and the like.

In the process of the present disclosure, the ratio of water absorbed in the supported material to the amount of hydrocarbyl aluminum compound in one embodiment can be from 1:1.25 to 1:1.42 for the in-situ supported MAO formation temperature in the range of −6° C. to −60° C. to obtain the supernate free of or low in free TMA, provided that when the in-situ supported MAO is formed at a higher cooling temperature, e.g., −6° C. to −12° C., the water:TMA ratio is controlled at 1:1.25 to 1:1.31, while at a lower cooling temperature, e.g., −12° C. or lower, the water:TMA ratio is controlled at 1:31 to 1:1.42. It should be understood that when the 1^{st} drop of water absorbed support is added to a TMA solution, the water:TMA ratio is close to 1:therefore, in theory, the water:TMA ratio can be 1:1.5 (the O:Al ratio in the active MAO formula (Al₄O₃Me₆)₄(AlMe₃)₂) or more, e.g., 1:3, 1:5, 1:10, 1:100, 1:1,000, 1:10,000 or higher, to form an active in-situ supported MAO composition. However, the end supernate will contain significant free TMA, e.g., >600 ppm, >1 wt %, >5 wt %, or higher.

TMA with other optinal aluminumalkyl compound in some embodiments of the process is present in an amount of about 1.5 to 30 wt % aluminum based on the weight of the isolated solid product, excluding Al in the support material, such as in alumina. Preferably, the amount of aluminum is between 4 wt % and 25 wt %, more preferably 6 wt % and 15 wt %, based on the total weight of the isolated solid product. More preferably, the optional aluminumalkyl compounds are compounds that make the modified supported MAO less soluble therefore to obtain the supernate with less or free of soluble aluminumalkyl species, such as AlR₂F, e.g., AlMe₂F, AlEtF₂, such as Al(C₆F₅)₃, AlMe(C₆F₅)₂, and the like.

### In-Situ Supported MAO

The supported MAO of the present disclosure are prepared in-situ by contacting the water saturated support, e.g., silica, as a slurry in an organic solvent or as solid without any solvent, with the TMA as a solution in an organic solvent. A preferred method to form the in-situ sMAO is the slow addition of the support slurry to the TMA solution, at a temperature in the range of −6° C. to −60° C., preferably at a temperature of from −10° C. to −50° C., such as from −12° C. up to −40° C., or less than −15° C., −20° C. or −30° C., so that the internal temperature of the reactor is maintained in a desired range, e.g., within 4° C., e.g., −10° C.±1° C., −15° C.±2° C., or −25° C.±2° C.; e.g., not higher than −6° C.

In at least one embodiment of the present disclosure, a high viscosity hydrocarbon solvent such as mineral oil is used at least partially to form the support slurry in order to produce a viscous slurry to reduce or avoid fast support settlement.

In at least one embodiment of the present disclosure, the mixture of hydrocarbyl aluminum and water saturated silica is agitated.

### Active MAO and Inactive MAO Gel Ratio Control

The active MAO formula (Al₄O₃Me₆)₄(TMA^{c})₁₋₂ was the targeted MAO composition, which is in theory derived from 17-18 eq TMA and 12 eq H₂O to give a TMA:water ratio of 1.42 or 1.50:1. The coordinated TMA (TMA^{c}) is in equilibrium with free TMA (Sinn, et al, “Formation, Structure, and Mechanism of Oligomeric Methylaluminoxane”, in Kaminsky (ed.), Metalorg. Cat. for Synth. & Polym., Springer-Verlag, 1999, pp 105). Experimental evidence strongly suggests that the coordinated TMA serves as the major active site to provide AlMe₂⁺ for catalyst precursor compound ionization and the free TMA serves as the alkylation agent (see Luo, Jain, and Harlan, ACS Annual Meeting, Conference Abstracts PMSE 126 and INOR 1169, Apr. 2-6, 2017; Luo, Wu, & Diefenbach, U.S. Pat. No. 9,090,720 (2015)).

It has been discovered that the active MAO formation as a major product requires two major critical conditions: 1) cold temperature, e.g., −8° C. or lower; and 2) excess TMA environment around the water molecules, e.g., at least 1.42:1 TMA:water ratio that matches the active MAO formula with at least one coordinated TMA, i.e., (Al₄O₃Me₆)₄(TMA^{c})₁. If any of the two conditions are not met, inactive MAO gel molecules (AlOMe)ₙ may form as the major product due to the active MAO molecules are the kinetic products tending to form more stable MAO gel molecules, as the energetic profile below (Scheme 1):

Experimental results agree with the energetic profile above, indicating that active MAO molecules in the solution form is unstable at ambient, e.g., >30 wt % MAO gel may form after 3-4 days at ambient for a 30 wt % MAO toluene solution. The MAO solution is therefore required to be stored at a cold temperature, e.g., in a practical cooling range of −20° C. to −30° C., to reduce the gelation process therefore to maintain the performance in more practical storage period, e.g., months, with a limited gel content, e.g., <5 wt % of the total MAO content. The gelation process is believed to go through the continuing MAO molecule dimerization process, i.e., two monomers dimerize to form a dimer, a monomer and a dimer dimerize to form a trimer, two dimers dimerize to form a tetramer, and so on, with the elimination of the coordinated TMA to result in larger and larger MAO molecules (therefore less and less total MAO molecule numbers) based on the experimental observation that free TMA content is gradually increased.

On the other hand, once the MAO molecules are supported, the gelation process is almost completed blocked likely due to the difficult immobility of the MAO molecules to meet and dimerize. The supported MAO therefore has a longer shelf life even at ambient, e.g., in 3 years at ambient under an inert environment to maintain 90% or a higher percentage of the activation efficiency.

Theoretically, the colder the reaction temperature, the less population of active MAO molecules can pass the energy barrier (E* in Scheme 1) to form the more stable MAO gel molecules. However, it is not practical for a commercial reactor to reach a very low temperature, e.g., lower than −60° C. Therefore there is a compromise between the practical cooling temperature and the amount of MAO gel molecules allowed in the system for the design of the commercial production conditions.

The supported MAO can also be heated to modify the supported MAO performance, such as to dimerize unsupported small MAO molecules and supported MAO molecules to reduce the amount of unsupported MAO molecule for a better operability in a slurry polymerization process due to the solubility of unsupported small MAO molecules, to increase the MAO molecule sizes for a weaker ion-paire when the supported MAO is used for activating a more positive charge rich metacenter and/or a more open ligand framework of a catalyst precursor compound, or to control the ratio of the supported MAO molecules to unsupported large MAO molecules for a desired comonomer distribution.

In at least one embodiment of the present disclosure, a portion of gel molecules is allowed to form under more practical reaction conditions therefore to obtain a supported catalyst system still with reasonable activities, e.g., at −8° C., −10° C., or −12° C. reaction temperature to allow less than about 40 wt %, less than about 30 wt %, or less than about 20 wt % gel formation based on the total MAO loaded on the support. Because the gel MAO molecule has a TMA:water uptake ratio close to 1:1, the supported MAO system containing a minor portion of MAO gel may display a total TMA:water uptake ratio smaller than the Al:0 ratio in the active MAO formula, i.e., <1.5:1 for active MAO with 2 coordinated TMA or <1.42:1 for active MAO with 1 coordinated TMA, e.g., about 1.25:1, about 1.30:1, or about 1.35:1. For example, the mixture of 3eq supported active MAO molecules (1 coordinated TMA) and 1 eq supported gelled MAO molecules gives the final TMA:water uptake ratio of % 1.42:1±14 1:1 =1.32:1.

In at least one embodiment of the present disclosure, the water absorbed silica is added to a cold TMA solution with a controlled addition rate therefore the reaction temperature can be maintained at a low temperature, e.g., −10° C.±1° C., −20° C.±2° C., −30° C.±4° C., or −60° C. 6° C. therefore the major portion, e.g., 60 wt %, 70 wt %, or 80 wt %, of the total water absorbed silica can have largely excess TMA around the water molecules, e.g., about 100:1, 80:1, 60:1, 40:1, 20:1, or 10:1 TMA:water ratio, to maximize the coordinated TMA formation.

In at least one embodiment of the present disclosure, the charged TMA:water ratio is so controlled that, at the end of the in-situ sMAO formation reaction, there is no TMA detectable or no more than 600 ppm TMA in the supernate determined with H¹ NMR spectroscopy. In at least one embodiment of the present disclosure, the charged TMA:water ratio is not higher than the Al:0 ratio in the composition containing both supported active MAO and supported inactive MAO gel molecules, i.e., the charged TMA:water ratio is not higher than the TMA:water uptatke ratio determined by the active MAO to inactive MAO gel ratio, e.g.

### Optional Heat Treatment of the Supported Aluminoxanes

The supported alumoxanes of the present disclosure, after being prepared in-situ, can be further treated at a higher temperature for a certain period of time either in the form of an organic solvent slurry or solid. In at least one embodiment, the high temperature treatment can be in the range of 60° C.-140° C., preferably 70° C.-120° C., and more preferably 85° C.-110° C. The heating time can be 30 minutes up to 12 hours, preferably 2-8 hours, and more preferably 3-6 hours. After such a heating treatment, some finished catalyst systems can have significant activity improvement, e.g., hafnocenes and other structurally open zirnonocene catalyst precursor compounds such as dimethylsilyl bridging zirconocenes, and some don't, e.g., structurally close zirconocenes such as unbridged zirconocenes. After such a heat treatment, the soluble MAO is limited therefore the catalyst operability is improved, especially in the slurry polymerization processes, presumably due to the dimerization oligamoerization of soluble small unanchored MAO molecules to become large insoluble MAO molecules, and/or the unanchored MAO molecules become anchored through the dimerization with the anchored MAO molecules, suggested by the observation of less THF extractable MAO on the finished catalyst systems after heating treatment. The heating treatment also reduces the hydroxyl groups in the finished catalyst systems indicated by IR spectroscopy; unreacted hydroxyl groups are considered as the deactivation factor for the finished catalyst systems.

The reaction mixture after contacting the support material having absorbed water and TMA in an organic solvent at a low temperature can also be spray dried in a spray drying reactor at a higher temperature to evaporate the solvents/volatiles and form the solid product with a desired average particle size and particle size distribution. The preferred temperature range is 60° C.-200° C., more preferred is 80° C.-190° C., and the most preferred is 90° C.-160° C.

### Catalyst Precursor Compounds

In at least one embodiment, the present disclosure provides a catalyst system comprising a catalyst precursor compound having a metal atom. The catalyst precursor compound can be a metallocene, half-metallocene, or post-metallocene single-site catalyst precursor compound. The metal can be a Group 3 through Group 12 metal atom, such as Group 3 through Group 10 metal atoms, or lanthanide Group atoms. The catalyst compound having a Group 3 through Group 12 metal atom can be monodentate or multidentate, such as bidentate, tridentate, or tetradentate, where a heteroatom of the catalyst, such as phosphorous, oxygen, nitrogen, or sulfur is chelated to the metal atom of the catalyst. Non-limiting examples include bis(phenolate)s. In at least one embodiment, the Group 3 through Group 12 metal atom is selected from Group 5, Group 6, Group 8, or Group 10 metal atoms. In at least one embodiment, a Group 3 through Group 10 metal atom is selected from Cr, Sc, Ti, Zr, Hf, V, Nb, Ta, Mn, Re, Fe, Ru, Os, Co, Rh, Ir, and Ni. In at least one embodiment, a metal atom is selected from Groups 4, 5, and 6 metal atoms. In at least one embodiment, a metal atom is a Group 4 metal atom selected from Ti, Zr, or Hf The oxidation state of the metal atom can range from 0 to +7, for example+1, +2, +3, +4, or +5, for example+2, +3 or +4.

A catalyst compound of the present disclosure can be a chromium or chromium-based catalyst. Chromium-based catalysts include chromium oxide (Cr03) and silylchromate catalysts. Chromium catalysts have been the subject of much development in the area of continuous fluidized-bed gas-phase polymerization for the production of polyethylene polymers. Such catalysts and polymerization processes have been described, for example, in U.S. Publication No. 2011/0010938 and U.S. Pat. Nos. 7,915,357; 8,129,484; 7,202,313; 6,833,417; 6,841,630; 6,989,344; 7,504,463; 7,563,851; 8,420,754; and 8,101,691.

Metallocene catalyst compounds as used herein include metallocenes comprising Group 3 to Group 12 metal complexes, preferably, Group 4 to Group 6 metal complexes, for example, Group 4 metal complexes. The metallocene catalyst compound of catalyst systems of the present disclosure may be unbridged metallocene catalyst compounds represented by the formula:

Cp^{A}Cp^{B}M′X′ₙ,

wherein each Cp^{A} and Cp^{B} is independently selected from cyclopentadienyl ligands and ligands isolobal to cyclopentadienyl, one or both Cp^{A} and Cp^{B} may contain heteroatoms, and one or both Cp^{A} and Cp^{B} may be substituted by one or more R″ groups. M′ is selected from Groups 3 through 12 atoms and lanthanide Group atoms. X′ is an anionic leaving group. n is 0 or an integer from 1 to 4. R″ is selected from alkyl, lower alkyl, substituted alkyl, heteroalkyl, alkenyl, lower alkenyl, substituted alkenyl, heteroalkenyl, alkynyl, lower alkynyl, substituted alkynyl, heteroalkynyl, alkoxy, lower alkoxy, aryloxy, alkylthio, lower alkylthio, arylthio, aryl, substituted aryl, heteroaryl, aralkyl, aralkylene, alkaryl, alkarylene, haloalkyl, haloalkenyl, haloalkynyl, heteroalkyl, heterocycle, heteroaryl, a heteroatom-containing group, hydrocarbyl, lower hydrocarbyl, substituted hydrocarbyl, heterohydrocarbyl, silyl, boryl, phosphino, phosphine, amino, amine, ether, and thioether.

In at least one embodiment, each Cp^{A} and Cp^{B} is independently selected from cyclopentadienyl, indenyl, fluorenyl, cyclopentaphenanthreneyl, benzindenyl, fluorenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, and hydrogenated versions thereof.

Unlimited examples of non-bridged metallocenes are:
bis(n-propylcyclopentadienyl)hafnium dichloride,
bis(n-propylcyclopentadienyl)hafnium dimethyl,
bis(n-propylcyclopentadienyl)zirconium dichloride,
bis(n-propylcyclopentadienyl)zirconium dimethyl,
bis(n-propylcyclopentadienyl)titanium dichloride,
bis(n-propylcyclopentadienyl)titanium dimethyl,
(n-propylcyclopentadienyl) (pentamethylcyclopentadienyl)zirconium dichloride,
(n-propylcyclopentadienyl) (pentamethylcyclopentadienyl)zirconium dimethyl,
(n-propylcyclopentadienyl) (pentamethylcyclopentadienyl)hafnium dichloride,
(n-propylcyclopentadienyl) (pentamethylcyclopentadienyl)hafnium dimethyl,
(n-propylcyclopentadienyl) (pentamethylcyclopentadienyl)titanium dichloride,
(n-propylcyclopentadienyl) (pentamethylcyclopentadienyl)titanium dimethyl,
(n-propylcyclopentadienyl) (tetramethylcyclopentadienyl)zirconium dichloride,
(n-propylcyclopentadienyl) (tetramethylcyclopentadienyl)zirconium dimethyl,
(n-propylcyclopentadienyl) (tetramethylcyclopentadienyl)hafnium dichloride,
(n-propylcyclopentadienyl) (tetramethylcyclopentadienyl)hafnium dimethyl,
(n-propylcyclopentadienyl) (tetramethylcyclopentadienyl)titanium dichloride,
(n-propylcyclopentadienyl) (tetramethylcyclopentadienyl)titanium dimethyl,
bis(cyclopentadienyl)hafnium dimethyl,
bis(n-butylcyclopentadienyl)hafnium dichloride,
bis(n-butylcyclopentadienyl)hafnium dimethyl,
bis(n-butylcyclopentadienyl)zirconium dichloride,
bis(n-butylcyclopentadienyl)zirconium dimethyl,
bis(n-butylcyclopentadienyl)titanium dichloride,
bis(n-butylcyclopentadienyl)titanium dimethyl,
bis(1-methyl-3-n-butylcyclopentadienyl)hafnium dichloride,
bis(1-methyl-3-n-butylcyclopentadienyl)hafnium dimethyl,
bis(1-methyl-3-n-butylcyclopentadienyl)zirconium dichloride,
bis(1-methyl-3-n-butylcyclopentadienyl)zirconium dimethyl,
bis(1-methyl-3-n-butylcyclopentadienyl)titanium dichloride, and
bis(1-methyl-3-n-butylcyclopentadienyl)titanium dimethyl.

The metallocene catalyst compound may be a bridged metallocene catalyst compound represented by the formula:

Cp^{A}(A)Cp^{B}M′X′ₙ,

wherein each Cp^{A} and Cp^{B} is independently selected from cyclopentadienyl ligands and ligands isolobal to cyclopentadienyl. One or both Cp^{A} and Cp^{B} may contain heteroatoms, and one or both Cp^{A} and Cp^{B} may be substituted by one or more R″ groups. M′ is selected from Groups 3 through 12 atoms and lanthanide Group atoms. X′ is an anionic leaving group. n is 0 or an integer from 1 to 4. (A) is selected from divalent alkyl, divalent lower alkyl, divalent substituted alkyl, divalent heteroalkyl, divalent alkenyl, divalent lower alkenyl, divalent substituted alkenyl, divalent heteroalkenyl, divalent alkynyl, divalent lower alkynyl, divalent substituted alkynyl, divalent heteroalkynyl, divalent alkoxy, divalent lower alkoxy, divalent aryloxy, divalent alkylthio, divalent lower alkylthio, divalent arylthio, divalent aryl, divalent substituted aryl, divalent heteroaryl, divalent aralkyl, divalent aralkylene, divalent alkaryl, divalent alkarylene, divalent haloalkyl, divalent haloalkenyl, divalent haloalkynyl, divalent heteroalkyl, divalent heterocycle, divalent heteroaryl, a divalent heteroatom-containing group, divalent hydrocarbyl, divalent lower hydrocarbyl, divalent substituted hydrocarbyl, divalent heterohydrocarbyl, divalent silyl, divalent boryl, divalent phosphino, divalent phosphine, divalent amino, divalent amine, divalent ether, divalent thioether. R″ is selected from alkyl, lower alkyl, substituted alkyl, heteroalkyl, alkenyl, lower alkenyl, substituted alkenyl, heteroalkenyl, alkynyl, lower alkynyl, substituted alkynyl, heteroalkynyl, alkoxy, lower alkoxy, aryloxy, alkylthio, lower alkylthio, arylthio, aryl, substituted aryl, heteroaryl, aralkyl, aralkylene, alkaryl, alkarylene, haloalkyl, haloalkenyl, haloalkynyl, heteroalkyl, heterocycle, heteroaryl, a heteroatom-containing group, hydrocarbyl, lower hydrocarbyl, substituted hydrocarbyl, heterohydrocarbyl, silyl, boryl, phosphino, phosphine, amino, amine, germanium, ether, and thioether.

In at least one embodiment, each of Cp^{A} and Cp^{B} is independently selected from cyclopentadienyl, n-propylcyclopentadienyl, indenyl, pentamethylcyclopentadienyl, tetramethylcyclopentadienyl, and n-butylcyclopentadienyl.

(A) may be O, S, NR′, or SiR′₂, where each R′ is independently hydrogen or C₁-C₂₀ hydrocarbyl.

Unlimited examples of the bridged metallocenes are: ethylene-bis(indenyl)Zr dichloride or dimethyl;
dimethylsilandiyl bis(4,5,6,7-indenyl)Zr dichloride or dimethyl;
dimethylsilandiyl bis(4,5,6,7-tetrahydro-indenyl)Zr dichloride or dimethyl;
dimethylsilandiyl(2-methyl-(4-(3′,5′-di-tert-butyl-4′-methoxy-phenyl)indenyl)(2-hexyl-4-(o-biphenyl)indenyl)Zr dichloride or dimethyl;
dimethylsilandiyl(2-ethyl-4-(3′,5′-di-tert-butyl-4′-methoxyphenyl)indenyl)(2-n-hexyl-4-(o-biphenyl)indenyl)Zr dichloride or dimethyl;
dimethylsilandiyl(2-propyl-4-(3′,5′-di-tert-butyl-4′-methoxyphenyl)indenyl)(2-n-hexyl-4-(o-biphenyl)indenyl)Zr dichloride or dimethyl;
dimethylsilandiyl(2-butyl-4-(3′,5′-di-tert-butyl-4′-methoxyphenyl)indenyl)(2-n-hexyl-4-(o-biphenyl)indenyl)Zr dichloride or dimethyl;
dimethylsilandiyl(2-methyl-4-(3′, 5′-bistrifluoromethyl-4′-methoxyphenyl)indenyl)(2-n-hexyl-4-(o-biphenyl)indenyl)Zr dichloride or dimethyl;
dimethylsilandiyl(2-methyl-4-(3′, 5′-bistrifluoromethyl-4′-methoxyphenyl)indenyl)(2-n-hexyl-4-(o-biphenyl)indenyl)Zr(CH₃)₂;
dimethylsilandiyl(2-ethyl-4-(3′,5′-bistrifluoromethyl-4′-methoxyphenyl)indenyl)(2-n-hexyl-4-(o-biphenyl)indenyl)Zr dichloride or dimethyl;
dimethylsilandiyl(2-propyl-4-(3′,5′-bistrifluoromethyl-4′-methoxyphenyl)indenyl)(2-n-hexyl-4-(o-biphenyl)indenyl)Zr dichloride or dimethyl;
dimethylsilandiyl(2-butyl-4-(3′,5′-bistrifluoromethyl-4′-methoxyphenyl)indenyl)(2-n-hexyl-4-(o-biphenyl)indenyl)Zr dichloride or dimethyl;
dimethylsilandiyl(2-methyl-4-(3′,5′-di-iso-propyl-4′-methoxyphenyl)indenyl)(2-n-hexyl-4-(o-biphenyl)indenyl)Zr dichloride or dimethyl;
dimethylsilandiyl(2-ethyl-4-(3′,5′-di-iso-propyl-4′-methoxyphenyl)indenyl)(2-n-hexyl-4-(o-biphenyl)indenyl)Zr dichloride or dimethyl;
dimethylsilandiyl(2-propyl-4-(3′,5′-di-iso-propyl-4′-methoxyphenyl)indenyl)(2-n-hexyl-4-(o-biphenyl)indenyl)Zr dichloride or dimethyl;
dimethylsilandiyl(2-butyl-4-(3′,5′-di-iso-propyl-4′-methoxyphenyl)indenyl)(2-n-hexyl-4-(o-biphenyl)indenyl)Zr dichloride or dimethyl;
dimethylsilandiyl(2-methyl-4-(3′,5′-di-phenyl-4′-methoxyphenyl)indenyl)(2-n-hexyl-4-(o-biphenyl)indenyl)Zr dichloride or dimethyl;
dimethylsilandiyl(2-ethyl-4-(3′,5′-di-phenyl-4′-methoxyphenyl)indenyl)(2-n-hexyl-4-(o-biphenyl)indenyl)Zr dichloride or dimethyl; dimethylsilandiyl(2-propyl-4-(3′,5′-di-phenyl-4′-methoxyphenyl)indenyl)(2-n-hexyl-4-(o-biphenyl)indenyl)Zr dichloride or dimethyl; and
dimethylsilandiyl(2-butyl-4-(3′,5′-di-phenyl-4′-methoxyphenyl)indenyl)(2-n-hexyl-4-(o-biphenyl)indenyl)Zr dichloride or dimethyl. dimethylsilandiyl(2-methyl-4-(3′,5′-di-tert-butyl-4′-methoxyphenyl)indenyl)(2-n-hexyl-4-(o-biphenyl)indenyl)Zr dichloride or dimethyl;
dimethylsilandiyl(2-methyl-4-(3′,5′-di-tert-butyl-4′-methoxyphenyl)(1,5,6,7-tetrahydro-s-indacenyl))(2-n-hexyl-4-(o-biphenyl)indenyl)Zr dichloride or dimethyl;
dimethylsilandiyl(2-methyl-4-phenyl-(1,5,6,7-tetrahydro-s-indacenyl))(2-isopropyl-4-(4′-t-butylphenyl)indenyl)Zr dichloride or dimethyl;
dimethylsilandiyl(2-methyl-4-(4′-t-butylphenyl)indenyl)(2-isopropyl-4-(4′-t-butylphenyl)indenyl)Zr dichloride or dimethyl;
dimethylsilandiyl(2-ethyl-4-(3′,5′-di-tert-butyl-4′-methoxyphenyl)indenyl)(2-n-hexyl-4-(o-biphenyl) indenyl)Zr dichloride or dimethyl;
dimethylsilandiyl(2-propyl-4-(3′,5′-di-tert-butyl-4′-methoxyphenyl)indenyl)(2-n-hexyl-4-(o-biphenyl)indenyl)Zr dichloride or dimethyl;
dimethylsilandiyl(2-butyl-4-(3′,5′-di-tert-butyl-4′-methoxyphenyl)indenyl)(2-n-hexyl-4-(o-biphenyl)indenyl)Zr dichloride or dimethyl;
dimethylsilandiyl(2-methyl-4-(3′, 5′-bistrifluoromethyl-4′-methoxyphenyl)indenyl)(2-n-hexyl-4-(o-biphenyl)indenyl)Zr dichloride or dimethyl;
dimethylsilandiyl(2-ethyl-4-(3′,5′-bistrifluoromethyl-4′-methoxyphenyl)indenyl)(2-n-hexyl-4-(o-biphenyl)indenyl)Zr dichloride or dimethyl;
dimethylsilandiyl(2-propyl-4-(3′,5′-bistrifluoromethyl-4′-methoxyphenyl)indenyl)(2-n-hexyl-4-(o-biphenyl)indenyl)Zr dichloride or dimethyl;
dimethylsilandiyl(2-butyl-4-(3′,5′-bistrifluoromethyl-4′-methoxyphenyl)indenyl)(2-n-hexyl-4-(o-biphenyl)indenyl)Zr dichloride or dimethyl;
dimethylsilandiyl(2-methyl-4-(3′,5′-di-iso-propyl-4′-methoxyphenyl)indenyl)(2-n-hexyl-4-(o-biphenyl)indenyl)Zr dichloride or dimethyl;
dimethylsilandiyl(2-ethyl-4-(3′,5′-di-iso-propyl-4′-methoxyphenyl)indenyl)(2-n-hexyl-4-(o-biphenyl)indenyl)Zr dichloride or dimethyl;
dimethylsilandiyl(2-propyl-4-(3′,5′-di-iso-propyl-4′-methoxyphenyl)indenyl)(2-n-hexyl-4-(o-biphenyl)indenyl)Zr dichloride or dimethyl;
dimethylsilandiyl(2-butyl-4-(3′,5′-di-iso-propyl-4′-methoxyphenyl)indenyl)(2-n-hexyl-4-(o-biphenyl)indenyl)Zr dichloride or dimethyl;
dimethylsilandiyl(2-methyl-4-(3′, 5′-di-phenyl-4′-methoxyphenyl)indenyl)(2-n-hexyl-4-(o-biphenyl)indenyl)Zr dichloride or dimethyl;
dimethylsilandiyl(2-ethyl-4-(3′,5′-di-phenyl-4′-methoxyphenyl)indenyl)(2-n-hexyl-4-(o-biphenyl)indenyl)Zr dichloride or dimethyl;
dimethylsilandiyl(2-propyl-4-(3′,5′-di-phenyl-4′-methoxyphenyl)indenyl)(2-n-hexyl-4-(o-biphenyl)indenyl)Zr dichloride or dimethyl;
dimethylsilandiyl(2-butyl-4-(3′,5′-di-phenyl-4′-methoxyphenyl)indenyl)(2-n-hexyl-4-(o-biphenyl)indenyl)Zr dichloride or dimethyl;
dimethylamidoborane(2-methyl-4-(3′,5′-di-tert-butyl-4′-methoxyphenyl)indenyl)(2-n-hexyl-4-(o-biphenyl)indenyl)Zr dichloride or dimethyl;
dimethylamidoborane(2-ethyl-4-(3′,5′-di-tert-butyl-4′-methoxyphenyl)indenyl)(2-n-hexyl-4-(o-biphenyl)indenyl)Zr dichloride or dimethyl;
dimethylamidoborane(2-propyl-4-(3′,5′-di-tert-butyl-4′-methoxyphenyl)indenyl)(2-n-hexyl-4-(o-biphenyl)indenyl)Zr dichloride or dimethyl;
dimethylamidoborane(2-butyl-4-(3′,5′-di-tert-butyl-4′-methoxyphenyl)indenyl)(2-n-hexyl-4-(o-biphenyl)indenyl)Zr dichloride or dimethyl;
dimethylamidoborane(2-methyl-4-(3′,5′-bistrifluoromethyl-4′-methoxyphenyl)indenyl)(2-n-hexyl-4-(o-biphenyl)indenyl)Zr dichloride or dimethyl;
dimethylamidoborane(2-ethyl-4-(3′,5′-bistrifluoromethyl-4′-methoxyphenyl)indenyl)(2-n-hexyl-4-(o-biphenyl)indenyl)Zr dichloride or dimethyl;
dimethylamidoborane(2-propyl-4-(3′,5′-bistrifluoromethyl-4′-methoxyphenyl)indenyl)(2-n-hexyl-4-(o-biphenyl)indenyl)Zr dichloride or dimethyl;
dimethylamidoborane(2-butyl-4-(3′,5′-bistrifluoromethyl-4′-methoxyphenyl)indenyl)(2-n-hexyl-4-(o-biphenyl)indenyl)Zr dichloride or dimethyl;
dimethylamidoborane(2-methyl-4-(3′,5′-di-iso-propyl-4′-methoxyphenyl)indenyl)(2-n-hexyl-4-(o-biphenyl)indenyl)Zr dichloride or dimethyl;
dimethylamidoborane(2-ethyl-4-(3′,5′-di-iso-propyl-4′-methoxyphenyl)indenyl)(2-n-hexyl-4-(o-biphenyl)indenyl)Zr dichloride or dimethyl;
dimethylamidoborane(2-propyl-4-(3′,5′-di-iso-propyl-4′-methoxyphenyl)indenyl)(2-n-hexyl-4-(o-biphenyl)indenyl)Zr dichloride or dimethyl;
dimethylamidoborane(2-tert-butyl-4-(3′,5′-di-iso-propyl-4′-methoxyphenyl)indenyl)(2-n-hexyl-4-(o-biphenyl)indenyl)Zr dichloride or dimethyl;
dimethylamidoborane(2-methyl-4-(3′,5′-di-phenyl-4′-methoxyphenyl)indenyl)(2-n-hexyl-4-(o-biphenyl)indenyl)Zr dichloride or dimethyl;
dimethylamidoborane(2-ethyl-4-(3′,5′-di-phenyl-4′-methoxyphenyl)indenyl)(2-n-hexyl-4-(o-biphenyl)indenyl)Zr dichloride or dimethyl;
dimethylamidoborane(2-propyl-4-(3′,5′-diphenyl-4′-methoxyphenyl)indenyl)(2-n-hexyl-4-(o-biphenyl)indenyl)Zr dichloride or dimethyl;
dimethylamidoborane(2-butyl-4-(3′,5′-diphenyl-4′-methoxyphenyl)indenyl)(2-n-hexyl-4-(o-biphenyl)indenyl)Zr dichloride or dimethyl;
di-iso-propylamidoborane(2-methyl-4-(3′,5′-di-tert-butyl-4′-methoxyphenyl)indenyl)(2-n-hexyl-4-(o-biphenyl)indenyl)Zr dichloride or dimethyl;
di-iso-propylamidoborane(2-ethyl-4-(3′,5′-di-tert-butyl-4′-methoxyphenyl)indenyl)(2-n-hexyl-4-(o-biphenyl)indenyl)Zr dichloride or dimethyl;
di-iso-propylamidoborane(2-propyl-4-(3′,5′-di-tert-butyl-4′-methoxyphenyl)indenyl)(2-n-hexyl-4-(o-biphenyl)indenyl)Zr dichloride or dimethyl;
di-iso-propylamidoborane(2-butyl-4-(3′,5′-di-tert-butyl-4′-methoxyphenyl)indenyl)(2-n-hexyl-4-(o-biphenyl)indenyl)Zr dichloride or dimethyl;
di-iso-propylamidoborane(2-methyl-4-(3′,5′-bistrifluoromethyl-4′-methoxyphenyl)indenyl)(2-n-hexyl-4-(o-biphenyl)indenyl)Zr dichloride or dimethyl;
di-iso-propylamidoborane(2-ethyl-4-(3′,5′-bistrifluoromethyl-4′-methoxyphenyl)indenyl)(2-n-hexyl-4-(o-biphenyl)indenyl)Zr dichloride or dimethyl;
di-iso-propylamidoborane(2-propyl-4-(3′,5′-bistrifluoromethyl-4′-methoxyphenyl)indenyl)(2-n-hexyl-4-(o-biphenyl)indenyl)Zr dichloride or dimethyl;
di-iso-propylamidoborane(2-butyl-4-(3′,5′-bistrifluoromethyl-4′-methoxyphenyl)indenyl)(2-n-hexyl-4-(o-biphenyl)indenyl)Zr dichloride or dimethyl;
di-iso-propylamidoborane(2-methyl-4-(3′,5′-di-iso-propyl-4′-methoxyphenyl)indenyl)(2-n-hexyl-4-(o-biphenyl) indenyl)Zr dichloride or dimethyl;
di-iso-propylamidoborane(2-ethyl-4-(3′,5′-di-iso-propyl-4′-methoxyphenyl)indenyl)(2-n-hexyl-4-(o-biphenyl) indenyl)Zr dichloride or dimethyl;
di-iso-propylamidoborane(2-propyl-4-(3′,5′-di-iso-propyl-4′-methoxyphenyl)indenyl)(2-n-hexyl-4-(o-biphenyl)indenyl)Zr dichloride or dimethyl;
di-iso-propylamidoborane(2-tert-butyl-4-(3′,5′-di-iso-propyl-4′-methoxyphenyl)indenyl)(2-n-hexyl-4-(o-biphenyl)indenyl)Zr dichloride or dimethyl;
di-iso-propylamidoborane(2-methyl-4-(3′,5′-diphenyl-4′-methoxyphenyl)indenyl)(2-n-hexyl-4-(o-biphenyl)indenyl)Zr dichloride or dimethyl;
di-iso-propylamidoborane(2-ethyl-4-(3′,5′-di-phenyl-4′-methoxyphenyl)indenyl)(2-n-hexyl-4-(o-biphenyl)indenyl)Zr dichloride or dimethyl;
di-iso-propylamidoborane(2-propyl-4-(3′,5′-diphenyl-4′-methoxyphenyl)indenyl)(2-n-hexyl-4-(o-biphenyl)indenyl)Zr dichloride or dimethyl;
di-iso-propylamidoborane(2-butyl-4-(3′,5′-diphenyl-4′-methoxyphenyl)indenyl)(2-n-hexyl-4-(o-biphenyl)indenyl)Zr dichloride or dimethyl;
bis(trimethylsilyl)amidoborane(2-methyl-4-(3′,5′-di-tert-butyl-4′-methoxyphenyl)indenyl)(2-n-hexyl-4-(o-biphenyl)indenyl)Zr dichloride or dimethyl;
bis(trimethylsilyl)amidoborane(2-ethyl-4-(3′,5′-di-tert-butyl-4′-methoxyphenyl)indenyl)(2-n-hexyl-4-(o-biphenyl)indenyl)Zr dichloride or dimethyl;
bis(trimethylsilyl)amidoborane(2-propyl-4-(3′,5′-di-t-butyl-4′-methoxyphenyl)indenyl)(2-n-hexyl-4-(o-biphenyl)indenyl)Zr dichloride or dimethyl;
bis(trimethylsilyl)amidoborane(2-butyl-4-(3′,5′-di-tert-butyl-4′-methoxyphenyl)indenyl)(2-n-hexane,4-(o-biphenyl)indenyl)Zr dichloride or dimethyl;
bis(trimethylsilyl)amidoborane(2-methyl-4-(3′,5′-bis-trifluoromethyl-4′-methoxyphenyl)indenyl)(2-n-hexane,4-(o-biphenyl)indenyl)Zr dichloride or dimethyl;
bis(trimethylsilyl)amidoborane(2-ethyl-4-(3′,5′-bis-trifluoromethyl-4′-methoxyphenyl)indenyl)(2-n-hexane,4-(o-biphenyl)indenyl)Zr dichloride or dimethyl;
bis(trimethylsilyl)amidoborane(2-propyl-4-(3′,5′-bis-trifluoromethyl-4′-methoxyphenyl)indenyl)(2-n-hexane,4-(o-biphenyl)indenyl)Zr dichloride or dimethyl;
bis(trimethylsilyl)amidoborane(2-butyl-4-(3′,5′-bis-trifluorometllyl-4′-methoxyphenyl)indenyl)(2-n-hexane,4-(o-biphenyl)indenyl)Zr dichloride or dimethyl;
bis(trimethylsilyl)amidoborane(2-methyl-4-(3′,5′-di-iso-propyl-4′-methoxyphenyl)indenyl)(2-n-hexane,4-(o-biphenyl)indenyl)Zr dichloride or dimethyl;
bis(trimethylsilyl)amidoborane(2-ethyl-4-(3′,5′-di-iso-propyl-4′-methoxyphenyl)indenyl)(2-n-hexane,4-(o-biphenyl)indenyl)Zr dichloride or dimethyl;
bis(trimethylsilyl)amidoborane(2-propyl-4-(3′,5′-di-iso-propyl-4′-methoxyphenyl)indenyl)(2-n-hexane,4-(o-biphenyl)indenyl)Zr dichloride or dimethyl;
bis(trimethylsilyl)amidoborane(2-butyl-4-(3′,5′-di-iso-propyl-4′-methoxyphenyl)indenyl)(2-n-hexane,4-(o-biphenyl)indenyl)Zr dichloride or dimethyl;
bis(trimethylsilyl)amidoborane(2-methyl-4-(3′,5′-diphenyl-4′-methoxyphenyl)indenyl)(2-n-hexane,4-(o-biphenyl)indenyl)Zr dichloride or dimethyl;
bis(trimethylsilyl)amidoborane(2-ethyl-4-(3′,5′-diphenyl-4′-methoxyphenyl)indenyl)(2-n-hexane,4-(o-biphenyl)indenyl)Zr dichloride or dimethyl;
bis(trimethylsilyl)amidoborane(2-propyl-4-(3′,5′-diphenyl-4′-methoxyphenyl)indenyl)(2-n-hexane,4-(o-biphenyl)indenyl)Zr dichloride or dimethyl;
bis(trimethylsilyl)amidoborane(2-butyl-4-(3′,5′-diphenyl-4′-methoxyphenyl)indenyl)(2-n-hexane,4-(o-biphenyl)indenyl)Zr dichloride or dimethyl;
dimethylsilandiyl bis(2-methyl-4-phenyl-indenyl)Zr dichloride or dimethyl;
dimethylsilandiyl bis(2-methyl-4-(3′,5-di-t-butylphenyl)indenyl)Zr dichloride or dimethyl;
dimethylsilandiyl bis(2-methyl-4-(3′,5-di-t-butyl-4-methoxyphenyl)indenyl)Zr dichloride or dimethyl;
dimethylsilandiyl bis(2-methyl-4-(4′-t-butylphenyl)indenyl) Zr dichloride or dimethyl;
dimethylsilandiyl bis(2-ethyl-4-phenyl-indenyl)Zr dichloride or dimethyl;
dimethylsilandiyl bis(2-ethyl-4-(3′,5-di-t-butylphenyl)indenyl)Zr dichloride or dimethyl;
dimethylsilandiyl bis(2-ethyl-4-(3′,5-di-t-butyl-4-methoxyphenyl)indenyl)Zr dichloride or dimethyl;
dimethylsilandiyl bis(2-ethyl-4-(4′-t-butylphenyl)indenyl) Zr dichloride or dimethyl;
dimethylsilandiyl bis(2-propyl-4-phenylindenyl) Zr dichloride or dimethyl;
dimethylsilandiyl bis(2-propyl-4-(3′,5-di-t-butylphenyl)indenyl)Zr dichloride or dimethyl;
dimethylsilandiyl bis(2-propyl-4-(3′,5-di-t-butyl-4-methoxyphenyl)indenyl)Zr dichloride or dimethyl;
dimethylsilandiyl bis(2-propyl-4-(4′-t-butylphenyl)indenyl) Zr dichloride or dimethyl;
dimethylsilandiyl bis(2-isopropyl-4-phenylindenyl) Zr dichloride or dimethyl;
dimethylsilandiyl bis(2-isopropyl-4-(3′,5-di-t-butylphenyl)indenyl)Zr dichloride or dimethyl;
dimethylsilandiyl bis(2-isopropyl-4-(4′-t-butylphenyl)indenyl) Zr dichloride or dimethyl;
dimethylsilandiyl bis(2-cyclopropyl-4-phenylindenyl) Zr dichloride or dimethyl;
dimethylsilandiyl bis(2-cyclopropyl-4-(3′,5-di-t-butylphenyl)indenyl)Zr dichloride or dimethyl;
dimethylsilandiyl bis(2-cyclopropyl-4-(4′-t-butylphenyl)indenyl) Zr dichloride or dimethyl;
dimethylsilandiyl bis(2-butyl-4-phenylindenyl) Zr dichloride or dimethyl;
dimethylsilandiyl bis(2-butyl-4-(3′,5-di-t-butylphenyl)indenyl)Zr dichloride or dimethyl;
dimethylsilandiyl bis(2-butyl-4-(4′-t-butylphenyl)indenyl) Zr dichloride or dimethyl;
dimethylsilandiyl bis(2-methyl-4-(2′-methylphenyl)indenyl)Zr dichloride or dimethyl;
dimethylsilandiyl bis(2-isopropyl-4-(2′-methylphenyl)indenyl)Zr dichloride or dimethyl;
dimethylsilandiyl bis(2-methyl-4-carbozolindenyl)Zr dichloride or dimethyl; and
dimethylsilandiyl bis(2-isopropyl-4-carbozolindenyl)Zr dichloride or dimethyl.

In at least one embodiment, many Cl symmetry bis-Cp metallocene catalysts capable of high Tm PP and/or diene incorporation can be represented by bridging substituted cyclopentadienyl and substituted indenyl catalyst precursor compounds as the formula (C1a):

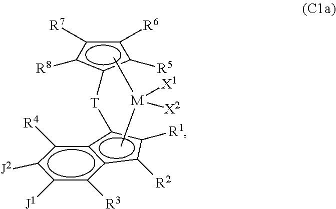

wherein:
M is a transition metal atom;
T is a bridging group;
each of X¹ and X² is a univalent anionic ligand, or X¹ and X² are joined to form a metallocycle ring;
R¹ is hydrogen, a halogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′2, —SR′, —OR, —SiR′₃, —OSiR′₃, —PR′₂, or —R″—SiR′₃, where R″ is C₁-C₁₀ alkyl and each R′ is hydrogen, halogen, C₁-C₁₀ alkyl, or C₆-C₁₀ aryl;
R³ is an unsubstituted C₄-C₆₂ cycloalkyl, a substituted C₄-C₆₂ cycloalkyl, an unsubstituted C₄-C₆₂ aryl, a substituted C₄-C₆₂ aryl, an unsubstituted C₄-C₆₂ heteroaryl, or a substituted C₄-C₆₂ heteroaryl;
each of R² and R⁴ is independently hydrogen, a halogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, wherein R″ is C₁-C₁₀ alkyl and each R′ is hydrogen, halogen, C₁-C₁₀ alkyl, or C₆-C₁₀ aryl;
each of R⁵, R⁶, R⁷, and R⁸ is independently hydrogen, a halogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, wherein R″ is C₁-C₁₀ alkyl and each R′ is hydrogen, halogen, C₁-C₁₀ alkyl, or C₆-C₁₀ aryl, or one or more of R⁵ and R⁶, R⁶ and R⁷, or R⁷ and R⁸ can be joined to form a substituted or unsubstituted C₄-C₆₂ saturated or unsaturated cyclic or polycyclic ring structure, or a combination thereof; and
each of J¹ and J² is joined to form a substituted or unsubstituted C₄-C₆₂ saturated or unsaturated cyclic or polycyclic ring structure, or a combination thereof.

In some embodiments of the present disclosure, M is a transition metal such as a transition metal of Group 3, 4, or 5 of the Periodic Table of Elements, such as a Group 4 metal, for example Zr, Hf, or Ti.

In some embodiments of the present disclosure, each of X¹ and X² is independently an unsubstituted C₁-C₄₀ hydrocarbyl (such as an unsubstituted C₂-C₂₀ hydrocarbyl), a substituted C₁-C₄₀ hydrocarbyl (such as a substituted C₂-C₂₀ hydrocarbyl), an unsubstituted C₄-C₆₂ aryl, a substituted C₄-C₆₂ aryl, an unsubstituted C₄-C₆₂ heteroaryl, a substituted C₄-C₆₂ heteroaryl, hydride, amide, alkoxide, sulfide, phosphide, halide, diene, amine, phosphine, ether, and a combination thereof, for example each of X¹ and X² is independently a halide or a C₁-C₅ alkyl, such as methyl. In some embodiments, each of X¹ and X² is independently chloro, bromo, methyl, ethyl, propyl, butyl, pentyl, hexyl, heptyl, octyl, nonyl, decyl, undecyl, or dodecyl. In some embodiments of the present disclosure, X¹ and X² form a part of a fused ring or a ring system.

In some embodiments, T is represented by the formula, (R*₂G)_{g}, wherein each G is C, Si, or Ge, g is 1 or 2, and each R* is, independently, hydrogen, halogen, an unsubstituted C₁-C₂₀ hydrocarbyl (such as methyl, ethyl, propyl, butyl, pentyl, hexyl, heptyl, octyl, nonyl, decyl, undecyl, or dodecyl), a substituted C₁-C₂₀ hydrocarbyl, or the two or more R* may join to form a substituted or unsubstituted, saturated, partially unsaturated or aromatic, cyclic or polycyclic substituent. In some embodiments of the present disclosure, T is a bridging group and is represented by R′₂C, R′₂Si, R′₂Ge, R′₂CCR′₂, R′₂CCR′₂CR′₂, R′₂CCR′₂CR′₂CR′₂, R′C═CR′, R′C═CR′CR′₂, R′₂CCR′═CR′CR′₂, R′C═CR′CR′═CR′, R′C═CR′CR′₂CR′₂, R′₂CSiR′₂, R′₂SiSiR′₂, R₂CSiR′₂CR′₂, R′₂SiCR′₂SiR′₂, R′C═CR′SiR′₂, R′₂CGeR′₂, R′₂GeGeR′₂, R′₂CGeR′₂CR′₂, R′₂GeCR′₂GeR′₂, R′₂SiGeR′₂, R′C═CR′GeR′₂, R′B, R′₂C—BR′, R′₂C—BR′—CR′₂, R′₂C—O—CR′₂, R′₂CR′₂C—O—CR′₂CR′₂, R′₂C—O—CR′₂CR′₂, R′₂C—O—CR′═CR′, R′₂C—S—CR′₂, R′₂CR′₂C—S—CR′₂CR′₂, R′₂C—S—CR′₂CR′₂, R′₂C—S—CR′═CR′, R′₂C—Se—CR′₂, R′₂CR′₂C—Se—CR′₂CR′₂, R′₂C—Se—CR₂CR′₂, R′₂C—Se—CR′═CR′, R′₂C—N═CR′, R′₂C—NR′—CR′₂, R′₂C—NR′—CR′₂CR′₂, R′₂C—NR′—CR′═CR′, R′₂CR′₂C—NR′—CR′₂CR′₂, R′₂C—P═CR′, or R′₂C—PR′—CR′₂ where each R′ is independently hydrogen or an unsubstituted C₁-C₂₀ hydrocarbyl (such as methyl, ethyl, propyl, butyl, pentyl, hexyl, heptyl, octyl, nonyl, decyl, undecyl, or dodecyl), a substituted C₁-C₂₀ hydrocarbyl, a C₁-C₂₀ halocarbyl, a C₁-C₂₀ silylcarbyl, or a C₁-C₂₀ germylcarbyl substituent, or two or more adjacent R′ join to form a substituted or unsubstituted, saturated, partially unsaturated or aromatic, cyclic or polycyclic substituent. In some embodiments of the present disclosure, T is a bridging group that includes carbon or silicon, such as dialkylsilyl, for example T is a CH₂, CH₂CH₂, C(CH₃)₂, (Ph)₂C, (p-(Et)₃SiPh)₂C, SiMe₂, SiPh₂, SiMePh, Si(CH₂)₃, Si(CH₂)₄, or Si(CH₂)₄.

In some embodiments, R¹ is hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), for example hydrogen, a substituted C₁-C₆ hydrocarbyl, or an unsubstituted C₁-C₆ hydrocarbyl.

In some embodiments, each of R² and R⁴ is independently hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), for example hydrogen, a substituted C₁-C₆ hydrocarbyl, or an unsubstituted C₁-C₆ hydrocarbyl.

In some embodiments, each of R⁵, R⁶, R⁷, and R⁸ is independently hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), such as a substituted C₁-C₆ hydrocarbyl, or an unsubstituted C₁-C₆ hydrocarbyl (such as methyl, ethyl, propyl, butyl, pentyl, or hexyl), or one or more of R⁵ and R⁶, R⁶ and R⁷, or R⁷ and R⁸ can be joined to form a substituted or unsubstituted C₄-C₂₀ saturated or unsaturated cyclic or polycyclic ring structure, or a combination thereof.

In some embodiments, one or more of R⁵ and R⁶, R⁶ and R⁷, or R⁷ and R⁸ can be joined to form a substituted or unsubstituted C₅C₈saturated or unsaturated cyclic or polycyclic ring structure, or a combination thereof.

In some embodiments, R³ is an unsubstituted C₄-C₂₀ cycloalkyl (e.g., cyclohexane, cyclypentane, cycloocatane, adamantane), or a substituted C₄-C₂₀ cycloalkyl.

In some embodiments, R³ is a substituted or unsubstituted phenyl, benzyl, carbazolyl, naphthyl, or fluorenyl.

In some embodiments, R³ is a substituted or unsubstituted aryl group represented by the formula:

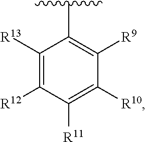

wherein each of R⁹R¹⁰, R¹¹, R¹², and R¹³ is independently hydrogen, an unsubstituted C₁-C₄₀ hydrocarbyl, a substituted C₁-C₄₀ hydrocarbyl, a heteroatom, a heteroatom-containing group, or two or more of R⁹R¹⁰, R¹¹, R¹² and R¹³ are joined together to form a C₄-C₆₂ cyclic or polycyclic ring structure, or a combination thereof.

In some embodiments of the present disclosure, each of R⁹R¹⁰, R¹¹, R¹² and R¹³ is independently hydrogen, a halogen, an unsubstituted C₁-C₄₀ hydrocarbyl, a substituted C₁-C₄₀ hydrocarbyl, an unsubstituted C₄-C₆₂ aryl (such as an unsubstituted C₄-C₂₀ aryl, such as a phenyl), a substituted C₄-C₆₂ aryl (such as a substituted C₄-C₂₀ aryl), an unsubstituted C₄-C₆₂ heteroaryl (such as an unsubstituted C₄-C₂₀ heteroaryl), a substituted C₄-C₆₂ heteroaryl (such as a substituted C₄-C₂₀ heteroaryl), —NR′₂, —SR′, —OR, —SiR′₃, —OSiR′₃, —PR′₂, or —R″—SiR′₃, where R″ is C₁-C₁₀ alkyl and each R′ is hydrogen, halogen, C₁-C₁₀ alkyl, or C₆-C₁₀ aryl. For example, each of R⁹R¹⁰, R, R¹² and R¹³ is independently hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), such as a substituted C₁-C₆ hydrocarbyl, or an unsubstituted C₁-C₆ hydrocarbyl (such as methyl, ethyl, propyl, butyl, pentyl, or hexyl), or two or more of R⁹, R¹⁰, R¹¹, R¹², and R¹³ can be joined to form a substituted or unsubstituted C₄-C₂₀ saturated or unsaturated cyclic or polycyclic ring structure, or a combination thereof.

In some embodiments of the present disclosure, at least one of R⁹, R¹⁰, R¹¹, R¹², and R¹³ is a phenyl.

In some embodiments of the present disclosure, each of J¹ and J² is joined form an unsubstituted C₄-C₂₀ cyclic or polycyclic ring, either of which may be saturated, partially saturated, or unsaturated. In some embodiments each J joins to form a substituted C₄-C₂₀ cyclic or polycyclic ring, either of which may be saturated or unsaturated. Examples include:

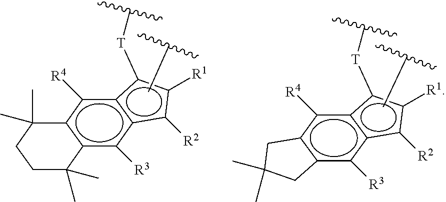

In at least one embodiment, C₁ symmetry bis-Cp metallocene catalysts can also be represented by bridging substituted cyclopentadienyl and substituted indenyl catalyst precursor compounds as the formula (C1b):

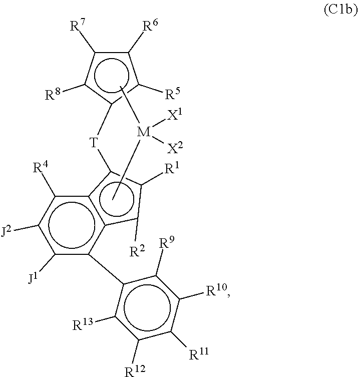

wherein M, T, J¹, J², X¹, X², R¹, R², and R⁴—R¹³ are described above.

In at least one embodiment, C₁ symmetry bis-Cp metallocene catalysts can also be represented by bridging substituted cyclopentadienyl and substituted indenyl catalyst precursor compounds as the formula (C1c):

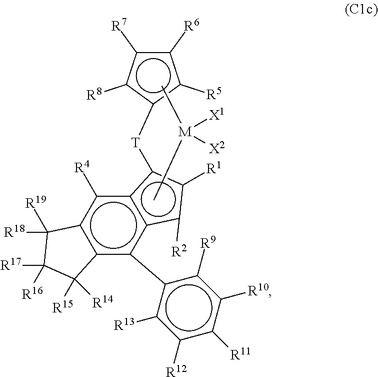

wherein:
each of R¹⁴, R⁵, R¹⁶, R¹⁷, R¹⁸, and R¹⁹ is independently hydrogen, an unsubstituted C₁-C₄₀ hydrocarbyl, a substituted C₁-C₄₀ hydrocarbyl, a heteroatom, a heteroatom-containing 5 group, or two or more of R¹⁴, R⁵, R¹⁶, R¹⁷, R¹⁸, and R¹⁹ are joined together to form a cyclic or polycyclic ring structure, or a combination thereof; and
M, T, X¹, X², R¹, R², and R⁴—R¹³ are described above.

In some embodiments, each of R¹⁴, R⁵, R¹⁶, R¹⁷, R¹⁸, and R¹⁹ is independently hydrogen, a halogen, an unsubstituted C₁-C₄₀ hydrocarbyl, a substituted C₁-C₄₀ hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, where R″ is C₁-C₁₀ alkyl and each R′ is hydrogen, halogen, C₁-C₁₀ alkyl, or C₆-C₁₀ aryl. For example, each of R¹⁴, R¹⁵, R¹⁶, R¹⁷, R¹⁸, and R¹⁹ is independently hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), such as a substituted C₁-C₆ hydrocarbyl, or an unsubstituted C₁-C₆ hydrocarbyl (such as methyl, ethyl, propyl, butyl, pentyl, or hexyl), or two or more of R¹⁴, R¹⁵, R¹⁶, R¹⁷, R¹⁸, and R¹⁹ can be joined to form a substituted or unsubstituted C₄-C₂₀ saturated or unsaturated cyclic or polycyclic ring structure, or a combination thereof.

In at least one embodiment, C₁ symmetry bis-Cp metallocene catalysts that can also be represented by bridging substituted cyclopentadienyl and substituted indenyl catalyst precursor compounds as the formula (C1d):

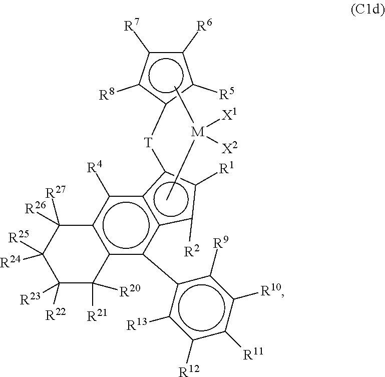

wherein:
each of R²⁰, R²¹, R²², R²³, R²⁴, R²⁵, R²⁶, R²⁷ is independently hydrogen, an unsubstituted C₁-C₄₀ hydrocarbyl, a substituted C₁-C₄₀ hydrocarbyl, a heteroatom, a heteroatom-containing group, or two or more of R²⁰, R²¹, R²², R²³, R²⁴, R²⁵, R²⁶, R²⁷ are joined together to form a cyclic or polycyclic ring structure, or a combination thereof; and
M, T, X¹, X², R¹, R², and R⁴—R¹³ are described above.

In some embodiments, each of R²⁰, R²¹, R²², R²³, R²⁴, R²⁵, R²⁶, R²⁷ is independently hydrogen, a halogen, an unsubstituted C₁-C₄₀ hydrocarbyl, a substituted C₁-C₄₀ hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, where R″ is C₁-C₁₀ alkyl and each R′ is hydrogen, halogen, C₁-C₁₀ alkyl, or C₆-C₁₀ aryl. For example, each of R²⁰, R²¹, R²², R²³, R²⁴, R²⁵, R²⁶, R²⁷ is independently hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), such as a substituted C₁-C₆ hydrocarbyl, or an unsubstituted C₁-C₆ hydrocarbyl (such as methyl, ethyl, propyl, butyl, pentyl, or hexyl), or two or more R²⁰, R²¹, R²², R²³, R²⁴, R²⁵, R²⁶, R²⁷ can be joined to form a substituted or unsubstituted C₄-C₂₀ saturated or unsaturated cyclic or polycyclic ring structure, or a combination thereof.

Useful examples of bridging C₁ metallocenes used for polyolefin products especially for propylene and diene polymerization and copolymerization include but are not limited to:

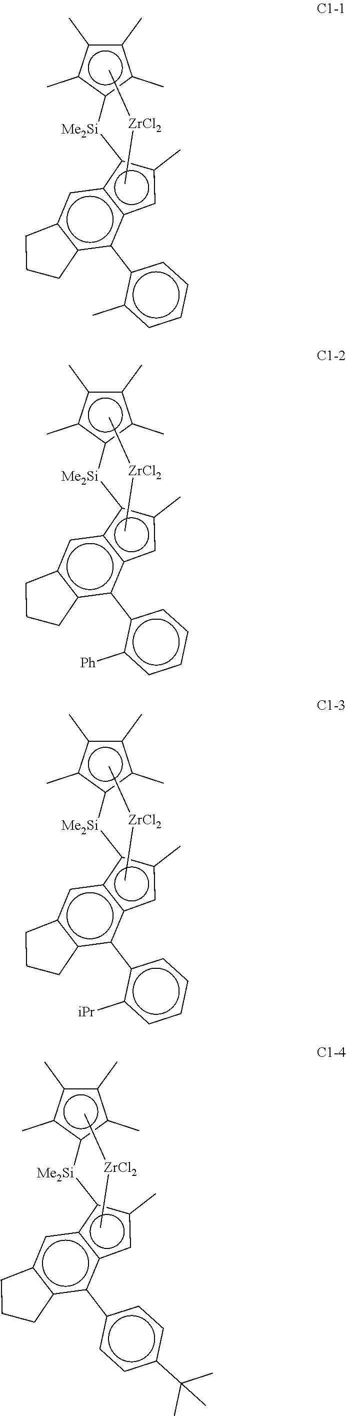

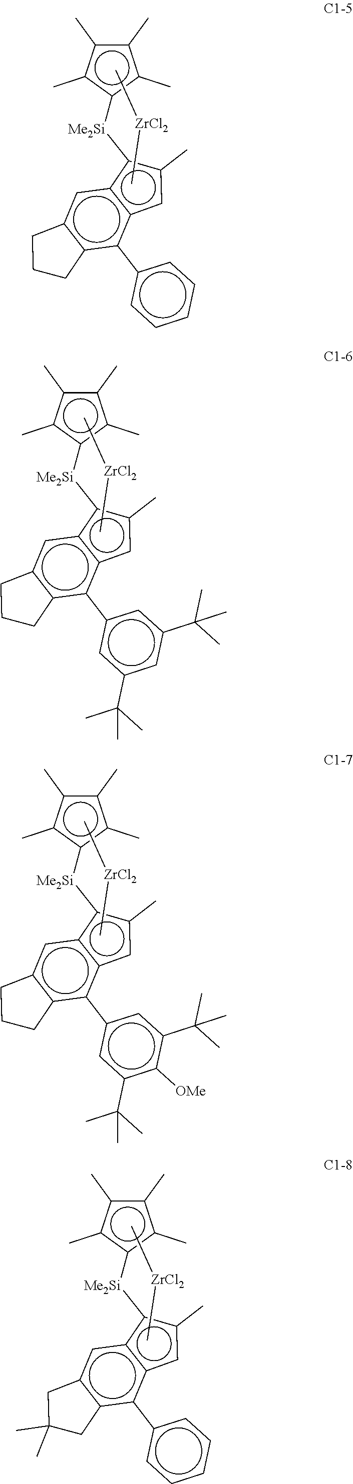

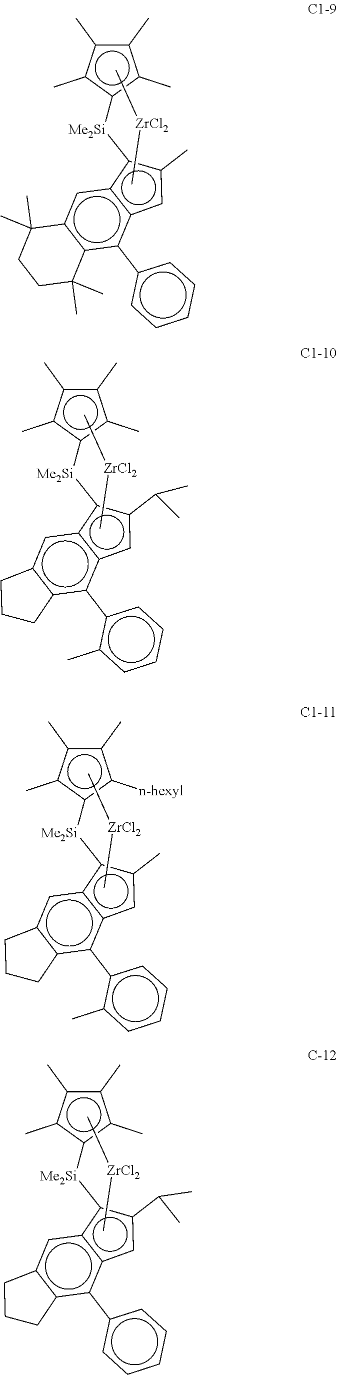

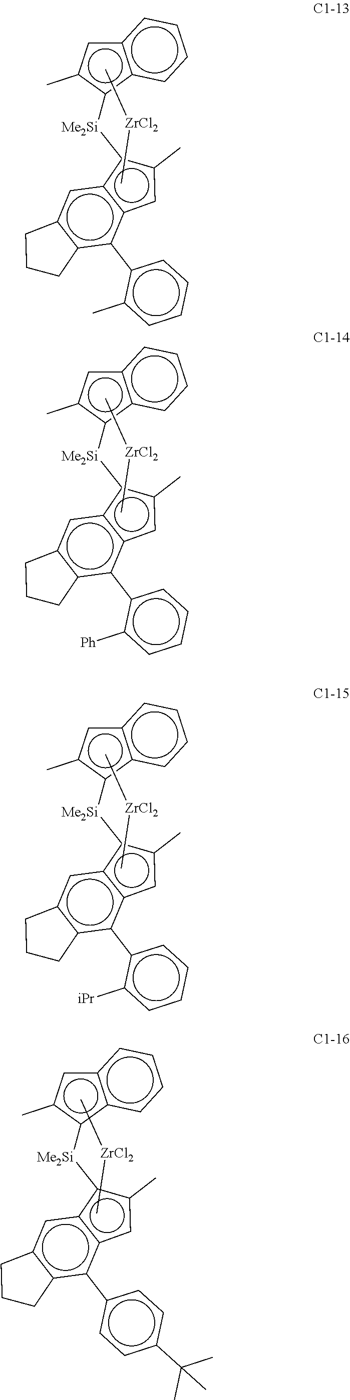

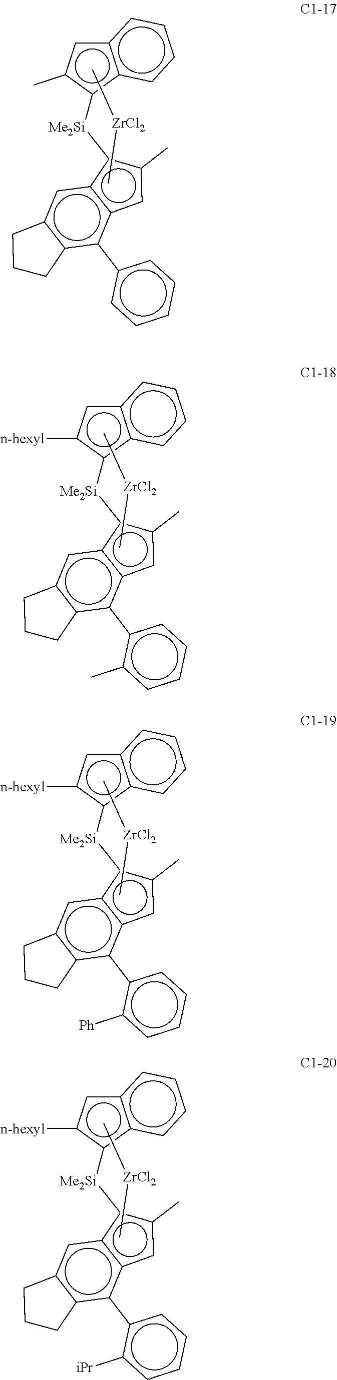

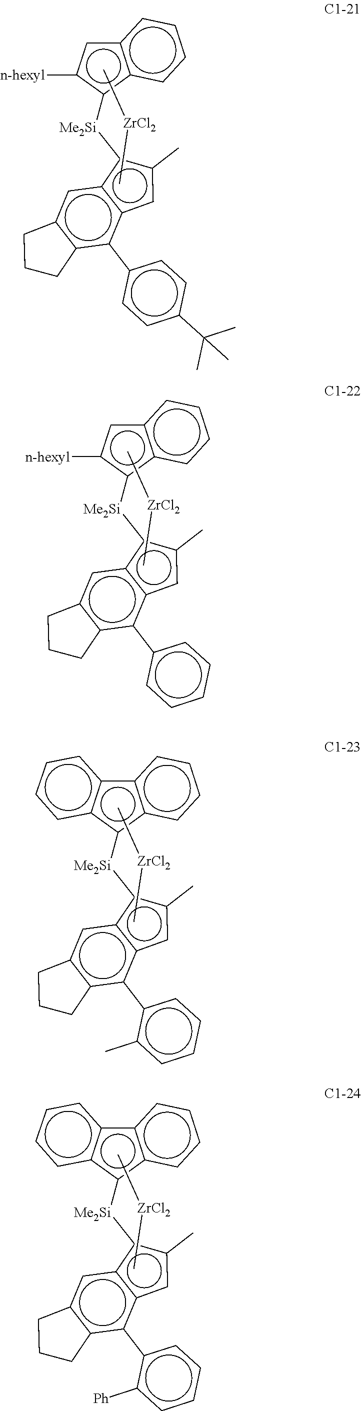

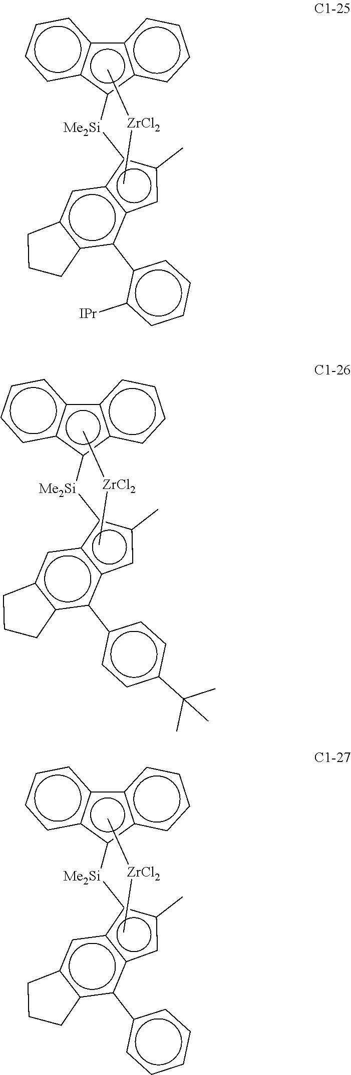

In another embodiment, the metallocene catalyst compound is represented by the formula:

T_{y}CpₘMGₙX_{q},

where Cp is independently a substituted or unsubstituted cyclopentadienyl ligand or substituted or unsubstituted ligand isolobal to cyclopentadienyl such as indenyl, fluorenyl and indacenyl. M is a Group 4 transition metal, such as Hf, Ti or Zr. G is a heteroatom group represented by the formula JR*_{z} where J is N, P, O or S, and R* is a linear, branched, or cyclic C₁-C₂₀ hydrocarbyl. z is 1 or 2. T is a bridging group. y is 0 or 1. X is a leaving group. m=1, n=1, 2 or 3, q=0, 1, 2, or 3, and the sum of m+n+q is equal to the oxidation state of the transition metal, preferably 2, 3, or 4, preferably 4.

In at least one embodiment, J is N, and R* is methyl, ethyl, propyl, butyl, pentyl, hexyl, heptyl, octyl, nonyl, cyclooctyl, cyclododecyl, decyl, undecyl, dodecyl, adamantyl or an isomer thereof. Preferred JR*_{z} groups include t-butyl amido and cyclododecylamido.

Preferred examples for the bridging group T include CH₂, CH₂CH₂, SiMe₂, SiPh₂, SiMePh, Si(CH₂)₃, Si(CH₂)₄, O, S, NPh, PPh, NMe, PMe, NEt, NPr, NBu, PEt, PPr, Me₂SiOSiMe₂, and PBu. In a preferred embodiment of the invention in any embodiment of any formula described herein, T is represented by the formula ER^{d}₂ or (ER^{d}₂)₂, where E is C, Si, or Ge, and each R^{d} is, independently, hydrogen, halogen, C₁ to C₂₀ hydrocarbyl (such as methyl, ethyl, propyl, butyl, pentyl, hexyl, heptyl, octyl, nonyl, decyl, undecyl, or dodecyl) or a C₁ to C₂₀ substituted hydrocarbyl, and two R^{d} can form a cyclic structure including aromatic, partially saturated, or saturated cyclic or fused ring system.

Each X is independently selected from the group consisting of hydrocarbyl radicals having from 1 to 20 carbon atoms, aryls, hydrides, amides, alkoxides, sulfides, phosphides, halides, dienes, amines, phosphines, ethers, and a combination thereof, (two Xs may form a part of a fused ring or a ring system), preferably each X is independently selected from halides, aryls and C₁ to C₅ alkyl groups, preferably each X is a phenyl, methyl, ethyl, propyl, butyl, pentyl, or chloro group.

The half-metallocene catalyst precursor compound may be selected from:
dimethylsilyl(tetramethylcyclopentadienyl)(cyclododecylamido)titanium dimethyl;
dimethylsilyl(tetramethylcyclopentadienyl)(cyclododecylamido)titanium dichloride;
dimethylsilyl(tetramethylcyclopentadienyl)(t-butylamido)titanium dimethyl;
dimethylsilyl(tetramethylcyclopentadienyl)(t-butylamido)titanium dichloride;
dimethylsilyl(cyclopentadienyl)(1-adamantylamido)M(R)₂;
dimethylsilyl(3-tertbutylcyclopentadienyl)(1-adamantylamido)M(R)₂;
dimethylsilyl(tetramethylcyclopentadienyl)(1-adamantylamido)M(R)₂;
dimethylsilyl(tetramethylcyclopentadienyl)(1-adamantylamido)M(R)₂;
μ-(CH₃)₂C(tetramethylcyclopentadienyl)(1-adamantylamido)M(R)₂;
dimethylsilyl(tetramethylcyclopentadienyl)(1-tertbutylamido)M(R)₂;
dimethylsilyl(fluorenyl)(1-tertbutylamido)M(R)₂;
(tetramethylcyclopentadienyl)(1-cyclododecylamido)M(R)₂;
μ-(C₆H)₂C(tetramethylcyclopentadienyl)(1-cyclododecylamido)M(R)₂; and
dimethylsilyl(1⁵-2,6,6-trimethyl-1,5,6,7-tetrahydro-s-indacen-1-yl)(tertbutylamido)M(R)₂;
   where M is selected from Ti, Zr, and Hf; and each R is selected from halogen or C₁ to C₅ alkyl (preferably chloro, bromo, methyl, ethyl, propyl, butyl, pentyl or isomers thereof).

In at least one embodiment, the catalyst precursor compound can be a post-metallocene single-site catalyst compound, such as a Group 3 through Group 12 transition metal directly binding to at least two hetero-atoms (e.g., O, N, P, S, CN, etc.) on at least one organic ligand through a and/or coordination bondings, optionally having a bonding between carbon on the organic ligand and the transition metal center as well, for example:

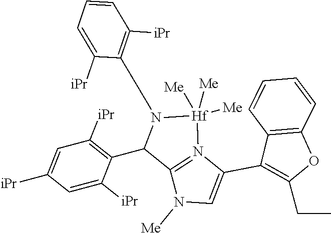

having one ligand with two nitrogen donors forming one N—Hf σ bond and one N—Hf coordination bond, whereas

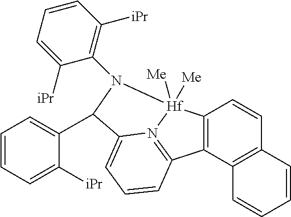

having one ligand with two nitrogen donors to form one N—Hf σ bond and one N—Hf coordination bond plus one C—Hf σ bond. The two of the at least two hetero-atoms on the organic ligand may form a 4, 5, 6, 7, 8 or more membered ring with the transition metal center, for example, the two compounds above have a 5 membered ring formed through two N and two C atoms on the ligand, and the metal center; for example, the compounds with the formula below has two 6 membered rings formed through N, O, three C atoms, and the metal center:

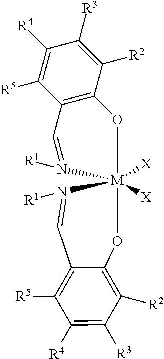

(R¹ to R⁵ are independently H or C₁ to C₂₀ organic groups, M is Ti, Zr, or Hf, and X is halide such as C₁ or alkyl such as Me); for example, the two Hf compounds below have two 7 membered rings plus one 6 membered ring formed through two O and three or four C atoms on the ligand and the metal center:

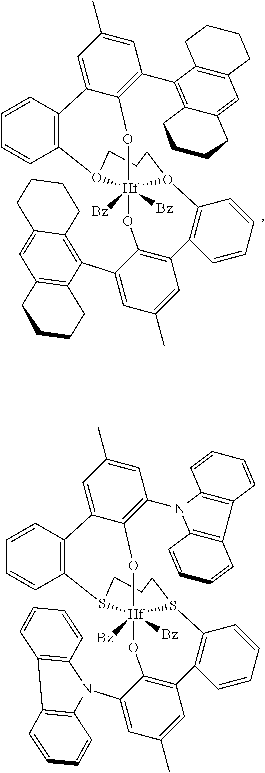

(Bz=benzyl); for example, the three compounds below have two 8 membered rings formed through N, O, and five C atoms on the ligand and the metal center:

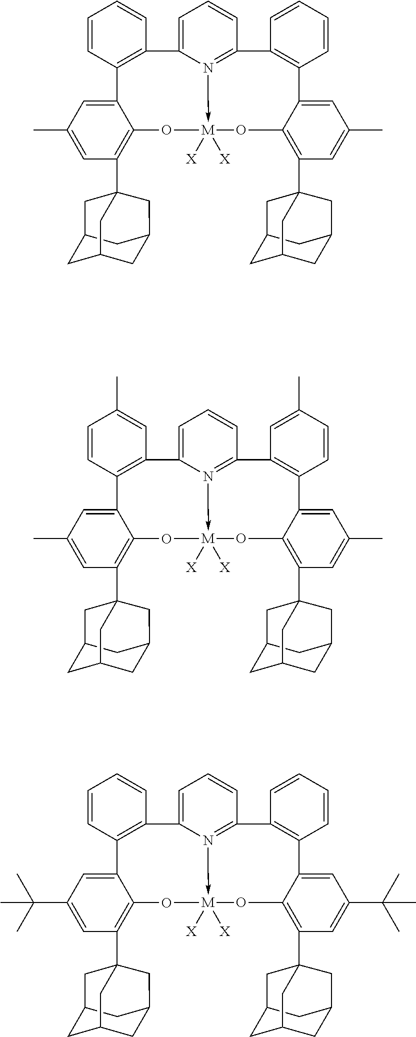

(M=Ti, Zr, or Hf; X=halide such as C₁ or alkyl such as Me of Bz); and the like.

Multiple catalyst precursors can also be used; for example, one bridged metallocene with one unbridged metallocene, one metallocene plus one half metallocene, one metallocene with one post-metallocene, or two post-metallocenes.

### Catalyst System Formation

Embodiments of the present disclosure include methods for preparing a catalyst system including contacting in an organic solvent the in-situ supported MAO with at least one catalyst precursor compound having a Group 3 through Group 12 metal atom or lanthanide metal atom. The catalyst precursor compound having a Group 3 through Group 12 metal atom or lanthanide metal atom can be a metallocene or post-metallocene catalyst precursor compound comprising a Group 4 metal.

In at least one embodiment, the in-situ supported MAO is heated prior to contact with the catalyst precursor compound.

The in-situ supported MAO formed as a slurry in an organic solvent can be immediately contacted with at least one catalyst precursor compound, or can be stored as is or isolated as a solid supported MAO for later use, to make the finished catalysts. The catalyst precursor compound can also be added as a solid or as a slurry of an organic solvent to the in-situ supported MAO. In at least one embodiment, the slurry of the in-situ supported MAO is contacted with the catalyst precursor compound for a period of time between about 0.02 hours and about 24 hours, such as between about 0.1 hours and 1 hour, 0.2 hours and 0.6 hours, 2 hours and about 16 hours, or between about 4 hours and about 8 hours.

The mixture of the catalyst precursor compound and the in-situ supported MAO may be heated to between about 30° C. and about 100° C., such as between about 45° C. and about 70° C., or without heating, such as at the room temperature. Contact times may be between about 0.02 hours and about 24 hours, such as between about 0.1 hours and 1 hour, 0.2 hours and 0.6 hours, 2 hours and about 16 hours, or between about 4 hours and about 8 hours.

Useful organic solvents are materials in which all or part of the reactants used herein, e.g., the in-situ supported MAO and the catalyst precursor compound, are at least partially soluble (or in the case of the solid support, suspended) and which are liquid at reaction temperatures. Non-limiting example solvents are non-cyclic alkanes with formula CₙH₍ₙ₊₂₎ where n is 3 to 30, such as propane, isobutane, butane, isopentane, hexane, n-heptane, octane, nonane, decane and the like, and cycloalkanes with formula CₙHₙ where n is 5 to 30, such as cyclopentane, methylcyclopentane, cyclohexane, methylcyclohexane and the like. Suitable organic solvents also include mixtures of any of the above. Although aromatic solvents such as benzene or toluene can also be used to make the finished catalyst with good performance, they are not preferred because non-anchored MAO on support is more soluble in these solvents and may cause high level MAO residue in the supemate that needs to be removed before contacting the catalyst precursor compound to make the finished catalyst to avoid catalyst operability issue and before the solvent can be reused.

If the in-situ supported MAO is isolated as a solid for later use, to make a finished catalyst using the isolated in-situ supported MAO solid, a solvent can be charged into a reactor, followed by the solid supported MAO. A catalyst precursor compound can then be charged into the reactor, such as a solution in an organic solvent or as a solid. The mixture can be stirred at a temperature, such as room temperature. Additional solvent may be added to the mixture to form a slurry having a desired consistency, such as from about 2 cc/g of silica to about 20 cc/g silica, such as about 4 cc/g. The solvent is then removed. Removing solvent dries the mixture and may be performed under a vacuum atmosphere, purged with inert atmosphere, heating of the mixture, or combinations thereof. For heating of the mixture, any suitable temperature can be used that evaporates the organic solvent. It is to be understood that reduced pressure under vacuum will lower the boiling point of the organic solvent depending on the pressure of the reactor. Solvent removal temperatures can be from about 10° C. to about 100° C., such as from about 60° C. to about 90° C., such as from about 60° C. to about 80° C., for example about 75° C. or less, such as about 65° C. or less. In at least one embodiment, removing solvent includes applying heat, applying vacuum, and applying nitrogen purged from bottom of the vessel by bubbling nitrogen through the mixture. The mixture is dried.

### Methods to Obtain Supernate Free of or Low in TMA

Embodiments of the present disclosure include methods for preparing an in-situ supported MAO or the derived finished catalyst system with the supemate after the formation of the in-situ supported MAO or the derived finished catalyst free of or low in free TMA in order to:
1) eliminate or reduce the potential fouling factor caused by the free TMA in the supemate reacting with the catalyst precursor compound to form non-supported soluble low activity species; and
2) enable the direct reuse of the supemate as solvent without further treatment.

The term charged TMA:water (or water:TMA) ratio refers to the ratio of TMA and water raw starting materials charged into the in-situ sMAO formation reaction equipment. The term TMA:water uptake ratio refers to the indirect measurement of the ratio of the charged water and TMA reacted to form MAO molecules loaded on silica, which is estimated through the H¹ NMR quantification of free TMA left in the supemate after the in-situ sMAO formation reaction, which can be calculated as below:TMA :water uptake ratio=(Charged TMA—Residual TMA):Charged water, by assuming that all water molecules are converted to MAO molecules due to more water reactive Al-Me units than the reactive OH units of the charged water. E.g., for charged TMA:water ratio=1.30:1, the water reactive Al-Me units on TMA (AlMe₃) are 1.30×3eq=3.90eq and the OH units of water are 2eq.

### Method 1

For a support containing absorbed water 6.5 (mmol/g support) or less, when the charged TMA:water ratio is controlled in the range of between 1.31:1 and 1.25:1, and the in-situ supported MAO formation temperature is controlled at not higher than −8° C., e.g., −10±2° C.-12±4° C., −15±7° C., −20±12° C., or not higher than −8° C. and not lower than −60° C., the supemate of the in-situ sMAO or the derived finished catalyst slurry free of TMA (H¹ NMR undetectable) or with a TMA concentration not more than 600 ppm (quantified with H¹ NMR method described in Example 22) can be obtained, as indicated in Table 2 Entries 1-4. Although the Table 2 data are generated from the catalysts made from the TMA concentration at about 20 wt % and a water absorbed silica slurry at about 22 wt %, higher or lower concentrations of the two ingredients, e.g., TMA concentration at 30-80 wt % or 1-3 wt % and the water absorbed silica slurry at 23-25 wt % or 1-10 wt %, can also be used. The water absorbed silica may also be added as a solid.

### Method 2

For a support containing absorbed water 5.0 (mmol/g support) or less, when the charged TMA:water ratio is controlled in the range of between 1.42:1 and 1.25:1, and the in-situ supported MAO formation temperature is controlled at not higher than −12° C., e.g., −14±2° C.-20±8° C., −30±18° C., or not higher than −12° C. and not lower than −60° C., the supernate of the finished catalyst slurry free of TMA (H¹ NMR undetectable) or with a TMA concentration not more than 600 ppm (quantified with H¹ NMR method described in Example 22) can be obtained, as indicated in Table 2 Entries 5-13. Although the Table 2 data are generated from the catalysts made from the TMA concentration at about 20 wt % and a water absorbed silica slurry at about 22 wt %, higher or lower concentrations of the two ingredients, e.g., TMA concentration at 30 wt %-80 wt % or 1 wt %-3 wt % and the water absorbed silica slurry at 23 wt %-25 wt % or 1 wt %-10 wt %, can also be used. The water absorbed silica may also be added as a solid.

### Method 3

For a support containing absorbed water 7.0-10.0 (mmol/g support), e.g., 7.0, 7.5, 8.0, 9.0, or 10.0 (mmol/g silica), when the charged TMA:water ratio is 1.20:1 or less, e.g., 1.15:1, and the in-situ sMAO formation temperature is controlled at not higher than −12° C. or lower, the supernate of the finished catalyst slurry free of TMA (1H NMR undetectable) or with a TMA concentration not more than 600 ppm (quantified with H¹ NMR method described in Example 22) can be obtained, provided that the higher the water content, the lower the cooling temperature required. For example, for 7.8 (mmol water/g support) loading, the sMAO formation temperature should be controlled at −12° C. or lower, and for 9.0 (mmol water/g support) loading, the sMAO formation temperature should be controlled at −20° C. or lower, as indicated in Table 2 Entries 15-16. Although the Table 2 data are generated from the catalysts made from the TMA concentration at about 20 wt % and from a water absorbed silica slurry of about 22 wt %, higher or lower concentrations of the two ingredients, e.g., TMA concentration at 30 wt %-80 wt % or 1 wt %-3 wt % and the water absorbed silica slurry at 23 wt %-25 wt % or 1 wt %-10 wt %. The water absorbed silica may also be added as a solid.

### Method 4

In some in-situ sMAO preparation cases, the sMAO containing both supported MAO (e.g., siloxy anchored MAO as sketched in Eq. 4 species C, a simplified structure C in the introduction section for better chemistry understanding purpose) and unsupported MAO (unanchored free MAO, as sketched in Eq. 4 species A, a simplified structure A in the introduction section for better chemistry understanding purpose) may need to be heated at a higher temperature, e.g., 85° C., 92° C., 100° C., or 110° C., presumably to form the MAO dimer to limit the soluble MAO portion for the derived catalysts used in slurry polymerization to prevent MAO leaching fouling, presumably due to species A becoming soluble in the solvent phase of the slurry polymerization media. The heating step may cause the generation of free TMA likely through Eq. 3:

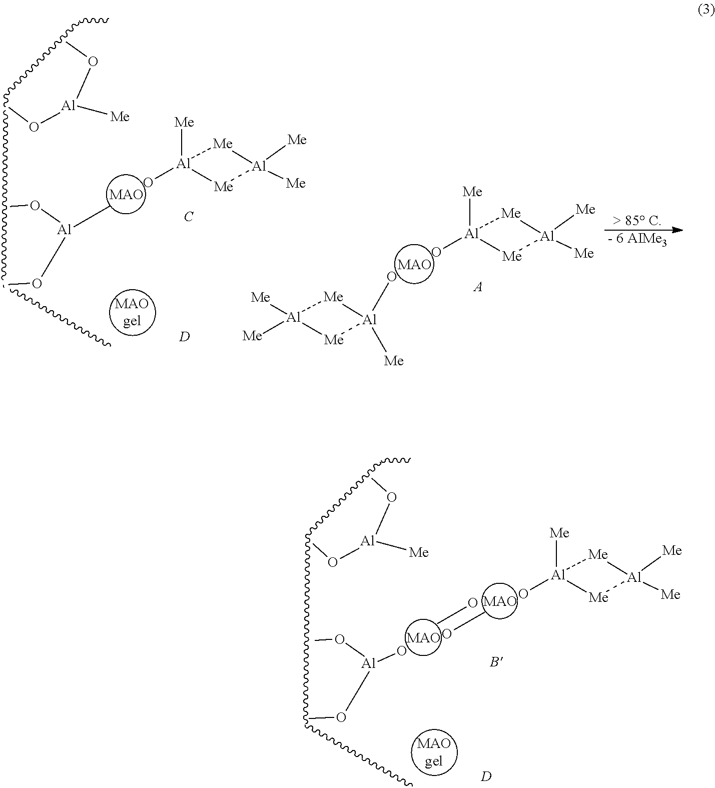

The heating generated free TMA can be removed by an additional matching amount of the same water absorbed silica for the preparation of the in-situ sMAO and therefore the total charged TMA:water ratio is decreased; e.g., under the conditions of Method 2 where the charged TMA:water is 1.42:1, additional 5% of water absorbed silica added to remove free TMA released by heating may decrease the charged TMA:water ratio, e.g., to 1.35:1, or 1.31:1. Method 5

Similar to Method 4 but instead of adding additional water absorbed silica, a calcined silica with controlled hydroxyl residue is used to add to remove free TMA left in the supe gate after the in-situ sMAO formation, including the heating generated TMA. 150° C.-875° C. calcined silica can be used with the amount so controlled that the amount of reactive hydroxyl residue on the silica matches the free TMA amount. A raw silica can also be used but the amount of water absorbed on the silica may be first quantified, e.g., through Grignard titration or LOD (loss on drying) methods, to determine the active protons and TMA matching.

### Polymerization Processes

In at least one embodiment of the present disclosure, a method includes polymerizing olefins to produce a polyolefin composition by contacting at least one olefin with a catalyst system of the present disclosure and obtaining the polyolefin composition. Polymerization may be conducted at a temperature of from about 0° C. to about 300° C., at a pressure of from about 0.35 MPa to about 10 MPa, and/or at a time up to about 400 minutes.

Embodiments of the present disclosure include polymerization processes where monomer (such as ethylene or propylene), and optionally comonomer, are contacted with a catalyst system comprising at least one catalyst compound and an activator, as described above. The at least one catalyst compound and activator may be combined in any order, and are combined typically prior to contact with the monomer.

Slurry and gas phase polymerizations may be conducted in the presence of an aliphatic hydrocarbon solvent/diluent/condensing agent (such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof; preferably aromatics are present in the solvent/diluent/condensing agent at less than 1 wt %, preferably less than 0.5 wt %, preferably at 0 wt % based upon the weight of the solvents/diluent/condensing agent).

In preferred embodiments, solvents/diluents used in the polymerizations are not aromatic, preferably aromatics are present in the solvent/diluent at less than 1 wt %, preferably less than 0.5 wt %, preferably less than 0 wt % based upon the weight of the solvents/diluents.

Monomers useful herein include substituted or unsubstituted C₂ to C₄₀ alpha olefins, preferably C₂ to C₂₀ alpha olefins, preferably C₂ to C₁₂ alpha olefins, preferably ethylene, propylene, butene, pentene, hexene, heptene, octene, nonene, decene, undecene, dodecene and isomers thereof. In a preferred embodiment, olefins include a monomer that is propylene and one or more optional comonomers comprising one or more ethylene or C₄ to C₄₀ olefin, preferably C₄ to C₂₀ olefin, or preferably C₆ to C₁₂ olefin. The C₄ to C₄₀ olefin monomers may be linear, branched, or cyclic. The C₄ to C₄₀ cyclic olefin may be strained or unstrained, monocyclic or polycyclic, and may include one or more heteroatoms and/or one or more functional groups. In another preferred embodiment, olefins include a monomer that is ethylene and an optional comonomer comprising one or more of C₃ to C₄₀ olefin, preferably C₄ to C₂₀ olefin, or preferably C₆ to C₁₂ olefin. The C₃ to C₄₀ olefin monomers may be linear, branched, or cyclic. The C₃ to C₄₀ cyclic olefins may be strained or unstrained, monocyclic or polycyclic, and may include heteroatoms and/or one or more functional groups.

Exemplary C₂ to C₄₀ olefin monomers and optional comonomers include ethylene, propylene, butene, pentene, hexene, heptene, octene, nonene, decene, undecene, dodecene, norbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, preferably hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and substituted derivatives thereof, preferably norbornene, norbornadiene, and dicyclopentadiene.

In at least one embodiment, one or more dienes are present in a polymer produced herein at up to about 10 wt %, such as from about 0.00001 wt % to about 1.0 wt %, such as from about 0.002 wt % to about 0.5 wt %, such as from about 0.003 wt % to about 0.2 wt %, based upon the total weight of the composition. In at least one embodiment, about 500 ppm or less of diene is added to the polymerization, such as about 400 ppm or less, such as about 300 ppm or less. In at least one embodiment, at least about 50 ppm of diene is added to the polymerization, or about 100 ppm or more, or 150 ppm or more.

Diolefin monomers include any hydrocarbon structure, preferably C₄ to C₃₀, having at least two unsaturated bonds, wherein at least two of the unsaturated bonds are readily incorporated into a polymer by either a stereospecific or a non-stereospecific catalyst(s). It is further preferred that the diolefin monomers be selected from alpha, omega-diene monomers (i.e., di-vinyl monomers). In at least one embodiment, the diolefin monomers are linear di-vinyl monomers, such as those containing from 4 to 30 carbon atoms. Non-limiting examples of dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, particularly preferred dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Non-limiting example cyclic dienes include cyclopentadiene, vinylnorbornene, norbornadiene, ethylidene norbornene, divinylbenzene, dicyclopentadiene or higher ring containing diolefins with or without substituents at various ring positions.

In at least one embodiment, where butene is the comonomer, the butene source may be a mixed butene stream comprising various isomers of butene. The 1-butene monomers are expected to be preferentially consumed by the polymerization process as compared to other butene monomers. Use of such mixed butene streams will provide an economic benefit, as these mixed streams are often waste streams from refining processes, for example, C₄ raffinate streams, and can therefore be substantially less expensive than pure 1-butene.

Polymerization processes of the present disclosure can be carried out in any suitable manner. Any suitable slurry or gas phase polymerization process can be used. Such processes can be run in a batch, semi-batch, or continuous mode.

Preferred polymerizations can be run at any temperature and/or pressure suitable to obtain the desired polyolefins. Typical temperatures and/or pressures include a temperature from about 0° C. to about 300° C., such as from about 20° C. to about 200° C., such as from about 35° C. to about 150° C., such as from about 40° C. to about 120° C., such as from about 65° C. to about 95° C.; and at a pressure from about 0.35 MPa to about 10 MPa, such as from about 0.45 MPa to about 6 MPa, or preferably from about 0.5 MPa to about 4 MPa.

In a typical polymerization, the run time of the reaction is up to about 400 minutes, such as from about 5 minutes to about 250 minutes, such as from about 10 minutes to about 120 minutes.

Hydrogen, may be added to a reactor for molecular weight control of polyolefins. In at least one embodiment, hydrogen is present in the polymerization reactor at a partial pressure of from about 0.001 psig and 50 psig (0.007 kPa to 345 kPa), such as from about 0.01 psig to about 25 psig (0.07 kPa to 172 kPa), such as from about 0.1 psig and 10 psig (0.7 kPa to 70 kPa). In one embodiment, 600 ppm or less of hydrogen is added, or 500 ppm or less of hydrogen is added, or 400 ppm or less or 300 ppm or less. In other embodiments, at least 50 ppm of hydrogen is added, or 100 ppm or more, or 150 ppm or more.

In an alternative embodiment, the activity of the catalyst is at least about 50 g/mmol/hour, such as about 500 or more g/mmol/hour, such as about 5,000 or more g/mmol/hr, such as about 750,000 or more g/mmol/hr where the amount of metallocene catalyst is in the denominator. In an alternative embodiment, the conversion of olefin monomer is at least about 10%, based upon polymer yield (weight) and the weight of the monomer entering the reaction zone, such as about 20% or more, such as about 30% or more, such as about 50% or more, such as about 80% or more.

Preferably, alumoxane is present at a molar ratio of aluminum to transition metal of a catalyst compound of less than about 500:1, such as less than about 300:1, such as less than about 100:1, such as less than about 1:1.

In a preferred embodiment, little or no scavenger is used in the process to produce the polyolefin composition. Preferably, scavenger (such as tri alkyl aluminum) is present at zero mol %. Alternatively, the scavenger is present at a molar ratio of scavenger metal to transition metal of the catalyst of less than about 100:1, such as less than about 50:1, such as less than about 15:1, such as less than about 10:1.

In a preferred embodiment, the polymerization: 1) is conducted at temperatures of 0° C. to 300° C. (preferably 25° C. to 150° C., preferably 40° C. to 120° C., preferably 45° C. to 80° C.); 2) is conducted at a pressure of atmospheric pressure to 10 MPa (preferably 0.35 MPa to 10 MPa, preferably from 0.45 MPa to 6 MPa, preferably from 0.5 MPa to 4 MPa); 3) wherein the catalyst system used in the polymerization comprises alumoxane at a molar ratio of aluminum to transition metal of a catalyst compound of less than 200:1, preferably 75:1 to 160:1, preferably 90:1 to 150:1, such as 95:1 to 125:1; 4) the polymerization preferably occurs in one reaction zone; 5) the productivity of the catalyst compound is at least 80,000 g/mmol/hr (preferably at least 150,000 g/mmol/hr, preferably at least 200,000 g/mmol/hr, preferably at least 250,000 g/mmol/hr, preferably at least 300,000 g/mmol/hr); 6) optionally scavengers (such as trialkyl aluminum compounds) are absent (e.g., present at zero mol %). Alternatively, the scavenger is present at a molar ratio of scavenger metal to transition metal of less than 100:1, preferably less than 50:1, preferably less than 15:1, preferably less than 10:1; and 8) optionally hydrogen is present in the polymerization reactor at a partial pressure of 0.001 psig to 50 psig (0.007 kPa to 345 kPa) (preferably from 0.01 psig to 25 psig (0.07 kPa to 172 kPa), more preferably 0.1 psig to 10 psig (0.7 kPa to 70 kPa)). In a preferred embodiment, the catalyst system used in the polymerization comprises no more than one catalyst compound. A “reaction zone”, also referred to as a “polymerization zone”, is a vessel where polymerization takes place, for example a batch reactor. When multiple reactors are used in either series or parallel configuration, each reactor is considered as a separate polymerization zone. For a multi-stage polymerization in both a batch reactor and a continuous reactor, each polymerization stage is considered as a separate polymerization zone. The polymerization can occur in one or more reaction zones.

Other additives may also be used in the polymerization, as desired, such as one or more scavengers, promoters, modifiers, chain transfer agents (such as diethyl zinc), reducing agents, oxidizing agents, hydrogen, aluminum alkyls, or silanes.

Chain transfer agents may be alkylalumoxanes, a compound represented by the formula AlR₃, ZnR₂ (where each R is, independently, a C₁-C₈ aliphatic radical, preferably methyl, ethyl, propyl, butyl, penyl, hexyl, heptyl, octyl or an isomer thereof) or a combination thereof, such as diethyl zinc, methylalumoxane, trimethylaluminum, triisobutylaluminum, trioctylaluminum, or a combination thereof.

Gas phase polymerization: Gas phase polymerization processes may be used herein. Generally, in a fluidized gas bed process used for producing polymers, a gaseous stream containing one or more monomers is continuously cycled through a fluidized bed in the presence of a catalyst under reactive conditions. The gaseous stream is withdrawn from the fluidized bed and recycled back into the reactor. Simultaneously, polymer product is withdrawn from the reactor and fresh monomer is added to replace the polymerized monomer. (See, for example, U.S. Pat. Nos. 4,543,399; 4,588,790; 5,028,670; 5,317,036; 5,352,749; 5,405,922; 5,436,304; 5,453,471; 5,462,999; 5,616,661; and 5,668,228; all of which are fully incorporated herein by reference.)

Slurry phase polymerization: Slurry phase polymerization processes may be used herein. A slurry polymerization process generally operates between 1 to about 50 atmosphere pressure range (15 psi to 735 psi, 103 kPa to 5068 kPa) or even greater and temperatures of 0° C. to about 120° C. In a slurry polymerization, a suspension of solid, particulate polymer is formed in a liquid polymerization diluent medium to which monomer and comonomers, along with catalysts, are added. The suspension including diluent is intermittently or continuously removed from the reactor where the volatile components are separated from the polymer and recycled, optionally after a distillation, to the reactor. The liquid diluent employed in the polymerization medium is typically an alkane having from 3 to 7 carbon atoms, preferably a branched alkane. The medium employed should be liquid under the conditions of polymerization and relatively inert. When a propane medium is used, the process should be operated above the reaction diluent critical temperature and pressure. Preferably, a hexane or an isobutane medium is employed. In another embodiment, the diluent is not aromatic, preferably aromatics are present in the diluent at less than 1 wt %, preferably less than 0.5 wt %, preferably less than 0 wt % based upon the weight of the diluents employed.

### Polyolefin Products

The present disclosure also relates to polyolefin compositions, such as resins, produced by the catalyst systems of the present disclosure. Polyolefins of the present disclosure can have no detectable aromatic solvent.

In at least one embodiment, a process includes utilizing a catalyst system of the present disclosure to produce propylene homopolymers or propylene copolymers, such as propylene-ethylene and/or propylene-alphaolefin (preferably C₃ to C₂₀) copolymers (such as propylene-hexene copolymers or propylene-octene copolymers) having an Mw/Mn of greater than about 1, such as greater than about 2, such as greater than about 3, such as greater than about 4.

In at least one embodiment, a process includes utilizing a catalyst system of the present disclosure to produce olefin polymers, preferably polyethylene and polypropylene homopolymers and copolymers. In at least one embodiment, the polymers produced herein are homopolymers of ethylene or copolymers of ethylene preferably having from about 0 mol % and 25 mol % of one or more C₃ to C₂₀ olefin comonomer (such as from about 0.5 mol % and 20 mol %, such as from about 1 mol % to about 15 mol %, such as from about 3 mol % to about 10 mol %). Olefin comonomers may be C₃ to C₁₂ alpha-olefins, such as one or more of propylene, butene, hexene, octene, decene, or dodecene, preferably propylene, butene, hexene, or octene. Olefin monomers may be one or more of ethylene or C₄ to C₁₂ alpha-olefin, preferably ethylene, butene, hexene, octene, decene, or dodecene, preferably ethylene, butene, hexene, or octene.

Polymers produced herein may have an Mw of from about 5,000 g/mol to about 1,000,000 g/mol (such as from about 25,000 g/mol to about 750,000 g/mol, such as from about 50,000 g/mol to about 500,000 g/mol), and/or an Mw/Mn of from about 1 to about 40 (such as from about 1.2 to about 20, such as from about 1.3 to about 10, such as from about 1.4 to about 5, such as from about 1.5 to about 4, such as from about 1.5 to about 3) as determined by GPC-4D as described in the Experimental section below.

The polyolefins produced herein contain 0 ppm of aromatic hydrocarbon. Preferably, the polyolefins produced herein contain 0 ppm of toluene.

### Experimental Materials

Chemicals: T rimethylaluminum was purchased from Sigma Aldrich (St. Louis, MO) or AkzoNobel (now Nouryon) and used as obtained, unless stated otherwise. Spray-dried silica ES70™ was purchased from PQ Corporation (now Ecovyst) and non spray-dried silica DM-L403 was purchased from AGC Chemicals. ES70X and ES70 are ES70™ silica that has been calcined at either 200° C., 400° C., or 875° C. for four hours. DM-L 403 silica is calcined at 200° C. for four hours. The silica parameters provided by vendors are summarized below:

TABLE 1
Silica Parameters

| | Particle | Surface | Pore | Pore |
|---|---|---|---|---|
| Silica | size (μm) | Area (m²/g) | Diameter (Å) | Volume (cc/g) |
| ES70 | 38 | 290 | 225 | 1.63 |
| ES70X | 51 | 291 | 217 | 1.58 |
| DM-L 403 | 40 | 325 | 266 | 2.16 |

Isohexane (in house plant grade solvent) and heptane (purchased from Sigma Aldrich anhydrous grade) were sparged with dry N₂ and then stored with activated 3 Angstrom molecular sieves in a container with 5 wt % −10 wt % molecular sieves at least for overnight before use. Water used is a lab deionized water. All reactions were performed under an inert nitrogen atmosphere, unless otherwise stated. All deuterated solvents were obtained from Cambridge Isotopes (Cambridge, MA) and dried over 3 Angstrom molecular sieves before use.

Equipment: Ace Glass 600 mL and 4L jacketed filter reactors with a Lauda chiller with Kryo 20 coolant capable of controlling temperature range from −30° C. to 150° C. The water absorbed silica slurry is charged into the well-sealed 600 mL reactor and metered into the 4L reactor through a Teflon tubing with additional rate controlled with positive N₂ pressure through a needle valve.

In-situ supported MAO silica calcined at 200° C., 400° C., or 875° C. with a water loading in the range of4.3-9.mmol/g and the charged TMA:water ratio in the range of 12.7:1 to 1.31:1 were used to investigate TMA residue in supemate (Table 2). Three metallocene catalyst precursor compounds representing different ligand structures and different metal centers were used to make the finished catalyst for activity comparisons:non-bridged zirconocene bis(1-methyl-3-butylcyclopentadienyl)zirconium dichloride (M1); bridged zirconocene dimethylsilyl-bis(4,5,6,7-tetrahydroindenyl)zirconium dimethyl (M2), and non-bridged hafnocene bis(proylcyclopentadienyl)hafnium dimethyl (M3). M1 has very good solubility in an aliphatic solvent, whereas M2 and M3 dichloride versions are significantly less soluble. Their methylated versions have higher solubility in preferred aliphatic solvents and are thus used.

TABLE 2
sMAO Formation Conditions, Supernate TMA Contents, and Finished Catalyst Activities

| | Silica | | | Charged | sMAO | TMA:H₂O | sMAO | TMA in | | |
|---|---|---|---|---|---|---|---|---|---|---|
| | (Calc. | H₂O | TMA | TMA:H₂O | Formation | Uptake | Heating | Supernate | | Activity |
| EX | Temp | Load | Charge | Ratio | Temp. | Ratio | Temp. | after | | vs. |
| # | ° C.) | (mmol/g silica) | | (mol:mol) | (° C.) | (mol:mol) | (° C.) | Heating | | standard¹ |
| 1 | ES70 | 6.5 | 8.5 | 1.31:1 | −10 | 1.31:1 | 92 | 450 | ppm² | M3 95% |
| | (400) | | | | | | | | | |
| 2 | ES70 | 6.5 | 8.5 | 1.31:1 | −10 | 1.31:1 | 92 | 0 | | M3 99% |
| | (200) | | | | | | | | | |
| 3 | ES70 | 6.5 | 8.5 | 1.31:1 | −10 | 1.31:1 | 65 | 0 | | M3 94% |
| | (200) | | | | | | | | | |
| 4 | ES70 | 6.5 | 8.5 | 1.31:1 | −10 | 1.31:1 | 92 | 168 | ppm | M3 110% |
| | (400) | | | | | | | | | |
| 5 | ES70X | 6.5 | 8.5 | 1.31:1 | −10 | 1.30:1 | 92 | 270 | ppm | M3 103% |
| | (200) | | | | | | | | | |
| 6 | ES70X | 5.0 | 7.5 | 1.50:1 | −10 | 1.37:1 | 62 | 7,580 | ppm | M2 100% |
| | (200) | | | | | | | | | |
| 7 | ES70X | 5.0 | 7.5 | 1.50:1 | −10 | 1.35:1 | 62 | 5,900 | ppm | M2 86% |
| | (200) | | | | | | | | | |
| 8 | ES70X | 4.7 | 6.8 | 1.45:1 | −10 | 1.39:1 | 60 | 1,110 | ppm | M1 100% |
| | (200) | | | | | | | | | |
| 9 | ES70X | 4.7 | 6.8 | 1.45:1 | −10 | 1.39:1 | 60 | 2,850 | ppm | M1 124% |
| | (200) | | | | | | | | | |
| 10 | ES70X | 5.0 | 7.1 | 1.42:1 | −10 | 1.39:1 | 60 | 950 | ppm | M1 117% |
| | (200) | | | | | | | | | |
| 11 | ES70X | 5.0 | 7.1 | 1.42:1 | −12 | 1.42:1 | 60 | 0 | | M1 140% |
| | (200) | | | | | | | | | |
| 12 | DM-L 403 | 4.8 | 6.8 | 1.42:1 | −14 | 1.42:1 | 92 | 0 | | — |
| | (200) | | | | | | | | | |
| 13 | ES70X | 4.8 | 6.8 | 1.42:1 | −10 | 1.37:1 | 85 | 2,090 | ppm | M2 160% |
| | (200) | | | | | | | | | |
| 14 | ES70X | 5.0 | 7.5 | 1.50:1 | −10 | 1.45:1 | 60 | 1,280 | ppm | M1 134% |
| | (200) | | | | | | | | | |
| 15 | ES70 | 6.0 | 8.0 | 1.33:1 | −5 | 0.96:1 | 92 | 10,000 | ppm | M3 10% |
| | (875) | | | | | | | | | |
| 16 | ES70 | 7.8 | 12.5 | 1.60:1 | −12 | 1.24:1 | 92 | 20,000 | ppm | M3 70% |
| | (400) | | | | | | | | | |
| 17 | ES70 | 9.1 | 13.9 | 1.52:1 | −20 | 1.17:1 | 92 | 5,550 | ppm | M3 60% |
| | (400) | | | | | | | | | |
| 18 | ES70X | 4.3 | 7.8 | 1.80:1 | −20 | 1.49:1 | 92 | 5,104 | ppm | M1 100% |
| | (200) | | | | | | | | | |
| 19 | ES70X | 4.3 | 54.6 | 12.7:1 | −20 | 1.41:1 | 92 | 15% | | M1 122% |
| | (200) | | | | | | | | | |
| 20 | ES70X | 4.3 | 7.8 | 1.81:1 | −10 | 1.34:1 | 92 | 7,914 | ppm | M1 95% |
| | (200) | | | | | | | | | |

| | | | | | | | | | |
|---|---|---|---|---|---|---|---|---|---|
| 21 | ES70X | 4.3 | 54.6 | 12.7:1 | −10 | 1.41:1 | 92 | 15% | M1 136% |
| | (200) | | | | | | | | |

¹Standard catalysts are M1, M2, and M3 metallocenes supported on the same silica derived supported regular MAO (W. R. Grace 30% MAO solution in toluene) with MAO loading of 6.2 mmol Al/g silica, to give activities of 2,912, 3,389, and 6,294 g/g cat/hr, respectively;
²before heating because the heating was applied on solid.

Example 1 (M3, 400° C. calcined ES70 silica, in-situ sMAO solid heated at 92° C.)
1. In the drybox, each of the 3 bottles (1L volume) was charged with 100 g of silica ES70 (400° C.), 360 g of isohexane, and 11.7 g of water. The 3 bottles containing total 300 g silica, 1080 g isohexane, and 35.1 g (1.95 mol) water were capped and sealed well with electrical tapes. The 3 bottles were taken out of the drybox and placed on a roller set at 80 rpm to roll for 2 hours. After 2 hours, the 3 bottles were brought back into the drybox.
2. 760 g of dry isohexane (3A molecular sieves overnight) was charged into the 4L reactor equipped with an anchor stir blade. The Lauda chiller was turned on with the temperature controller set at −30° C. The stirrer was turned on and set to 170 rpm.
3. After the isohexane was cooled to −1° C., the filtration cap at the reactor bottom was checked to ensure no leaking, 184.2 g (2.55 mol) of neat TMA was added to the reactor. The TMA:water ratio is 2.55:1.95 or 1.31:1.
4. While waiting for the TMA solution to reach −15° C., 1 of the 3 bottles of water absorbed silica slurry was transferred to the 600 mL reactor and cooled to about −5° C. and stirred to ensure a good mixing.
5. After the TMA solution temperature reach −15° C., started the addition of the water absorbed silica in a rate that maintained the reaction temperature between −9° C. to −12° C. under 250 rpm.
6. After the addition of silica slurry, the agitation was adjusted to 170 rpm, the jacket temperature was increased to 1° C. and maintained for 30 minutes and then to ambient.
7. The agitation was stopped and the solvent was removed through the reactor bottom filter under vacuum. An ¹H-NMR spectrum was acquired for the filtrate in THF-d8 (deuterated tetrahydrofuran) and showed neither MAO nor TMA.
8. The wet solid was dried in the 4L jacketed filter reactor at ambient for 2 hours, and then set heating temperature at 100° C. to allow solid temperature at 92° C. for 4 hours. Yield: 441.5 g.
9. 1.0 g sMAO from above was slurried into 4 g isohexane in a 20 mL vial and then added 19.0 mg M3 metallocene.
10. The slurry was placed on a shaker to shake for 1 hour, filtered through a frit, and then vacuum dried for 1 hour. Yield 1.0 g. The catalyst was tested for gas-phase ethylene polymerization in a 2L autoclave salt-bed reactor with procedure described in Example 22.

Example 2 (M3, 200° C. calcined ES70 silica, in-situ sMAO slurry heated at 92° C.)
1. In the drybox, each of the 3 bottles (1L volume) was charged with 100 g of silica ES70 (200° C.), 360 g of heptane, and 11.7 g of water. The 3 bottles containing total 300 g silica, 1080 g heptane, and 35.1 g (1.95 mol) water were capped and sealed well with electrical tapes. The 3 bottles were taken out of the drybox and placed on a roller set at 80 rpm to roll for 2 hours. After 2 hours, the 3 bottles were brought back into the drybox.
2. 760 g of dry heptane (3A molecular sieves overnight) was charged into the 4L reactor equipped with an anchor stir blade. The Lauda chiller was turned on with the temperature controller set at −30° C. The stirrer was turned on and set to 170 rpm.
3. After the heptane was cooled to −1° C., the filtration cap at the reactor bottom was checked to ensure no leaking, 184.2 g (2.55 mol) of neat TMA was added to the reactor. The TMA:water ratio is 2.55:1.95 or 1.31:1.
4. While waiting for the TMA solution to reach −15° C., 1 of the 3 bottles of water absorbed silica slurry was transferred to the 600 mL reactor and cooled to about −5° C. and stirred to ensure a good mixing.
5. After the TMA solution temperature reach −15° C., started the addition of the water absorbed silica in a rate that maintained the reaction temperature between −9° C. to −12° C. under 250 rpm.
6. After the addition of silica slurry, the agitation was adjusted to 170 rpm, the jacket temperature was increased to 1° C. and maintained for 30 minutes and then to ambient.
7. The agitation was stopped to allow the solid to settle. An ¹H-NMR spectrum was acquired for the filtrate in THF-d8 (deuterated tetrahydrofuran) and showed neither MAO nor TMA.
8. The stirrer was turned on again and set at 170 rpm slurry was then heated by setting the heater to 96° C. to allow the reaction temperature to be 92° C.-93° C. and maintained for 4 hours.
9. After heating, the slurry was cooled to 25° C. and the stirrer was increased to 300 rpm, 8.45 g M3 metallocene was added.
10. After the M3 addition, the stirrer was reduced to 170 rpm for 2 hours.
11. The slurry was filtered, washed with 2x 1L isohexane, and dried overnight under vacuum at ambient. Yield: 445.5 g. The catalyst was tested for gas-phase ethylene polymerization in a 2L autoclave salt-bed reactor with procedure described in Example 22.

Example 3 (M3, 200° C. calcined ES70 silica, in-situ sMAO slurry heated at 65° C.)
1. In the drybox, each of the 3 bottles (1L volume) was charged with 100 g of silica ES70 (200° C.), 360 g of heptane, and 11.7 g of water. The 3 bottles containing total 300 g silica, 1080 g heptane, and 35.1 g (1.95 mol) water were capped and sealed well with electrical tapes. The 3 bottles were taken out of the drybox and placed on a roller set at 80 rpm to roll for 2 hours. After 2 hours, the 3 bottles were brought back into the drybox.
2. 715 g of dry heptane (3A molecular sieves overnight) was charged into the 4L reactor equipped with an anchor stir blade. The Lauda chiller was turned on with the temperature controller set at −30° C. The stirrer was turned on and set to 200 rpm.
3. After the heptane was cooled to −1° C., the filtration cap at the reactor bottom was checked to ensure no leaking, 184.2 g (2.55 mol) of neat TMA was added to the reactor. The TMA:water ratio is 2.55:1.95 or 1.31:1.
4. While waiting for the TMA solution to reach −15° C., 1 of the 3 bottles of water absorbed silica slurry was transferred to the 600 mL reactor and cooled to about −5° C. and stirred to ensure a good mixing.
5. After the TMA solution temperature reach −15° C., started the addition of the water absorbed silica in a rate that maintained the reaction temperature between −9° C. to −12° C. under 300 rpm.
6. After the addition of silica slurry, the agitation was adjusted to 200 rpm, the jacket temperature was increased to 1° C. and maintained for 30 minutes and then to ambient.
7. The slurry was then heated by setting the heater to 68° C. to allow the reaction temperature to be about 65° C. and maintained for 4 hours.
8. The temperature was then reduced to ambient (−21° C.). The stirrer was turned off to allow the solid to settle. An ¹H-NMR spectrum was acquired for the supernate in THF-d8 (deuterated tetrahydrofuran) and showed neither MAO nor TMA.
9. The stirrer was turned on and set at 60 rpm for overnight.
10. The stirrer was increased to 300 rpm, 8.84 g M3 metallocene was added.
11. After the M3 addition, the stirrer was reduced to 200 rpm for 2 hours.
12. The slurry was filtered, washed with 2x 1L isohexane, and dried overnight under vacuum at ambient. Yield: 459 g. The catalyst was tested for gas-phase ethylene polymerization in a 2L autoclave salt-bed reactor with procedure described in Example 22.

Example 4 (M3, 400° C. calcined ES70 silica, in-situ sMAO slurry heated at 92° C.)
1. In the drybox, each of the 3 bottles (1L volume) was charged with 100 g of silica ES70 (400° C.), 360 g of heptane, and 11.7 g of water. The 3 bottles containing total 300 g silica, 1080 g heptane, and 35.1 g (1.95 mol) water were capped and sealed well with electrical tapes. The 3 bottles were taken out of the drybox and placed on a roller set at 80 rpm to roll for 2 hours. After 2 hours, the 3 bottles were brought back into the drybox.
2. 700 g of dry heptane (3A molecular sieves overnight) was charged into the 4L reactor equipped with an anchor stir blade. The Lauda chiller was turned on with the temperature controller set at −30° C. The stirrer was turned on and set to 200 rpm.
3. After the heptane was cooled to −1° C., the filtration cap at the reactor bottom was checked to ensure no leaking, 184.2 g (2.55 mol) of neat TMA was added to the reactor. The TMA:water ratio is 2.55:1.95 or 1.31:1.
4. While waiting for the TMA solution to reach −15° C., 1 of the 3 bottles of water absorbed silica slurry was transferred to the 600 mL reactor and cooled to about −5° C. and stirred to ensure a good mixing.
5. After the TMA solution temperature reach −15° C., started the addition of the water absorbed silica in a rate that maintained the reaction temperature between −9° C. to −12° C. under 300 rpm.
6. After the addition of silica slurry, the agitation was adjusted to 200 rpm, the jacket temperature was increased to 1° C. and maintained for 30 minutes and then to ambient.
7. The slurry was then heated by setting the heater to 96° C. to allow the reaction temperature to be 92° C.-93° C. and maintained for 4 hours.
8. The temperature was then reduced to ambient (−21° C.). The stirrer was turned off to allow the solid to settle. An ¹H-NMR spectrum was acquired for the supernate in THF-d8 (deuterated tetrahydrofuran) and showed 170 ppm TMA.
9. The stirrer was turned on and set at 60 rpm for overnight.
10. The stirrer was increased to 300 rpm, 8.45g M3 metallocene was added.
11. After the M3 addition, the stirrer was reduced to 200 rpm for 2 hours.
12. The slurry was filtered, washed with 2x 1L isohexane, and dried overnight under vacuum at ambient. Yield: 458.8 g. The catalyst was tested for gas-phase ethylene polymerization in a 2L autoclave salt-bed reactor with procedure described in Example 21.

Example 5 (M3, 200° C. calcined ES70X silica, in-situ sMAO slurry heated at 92° C.)
1. In the drybox, each of the 3 bottles (1L volume) was charged with 100 g of silica ES70X (200° C.), 360 g of heptane, and 11.7 g of water. The 3 bottles containing total 300 g silica, 1080 g heptane, and 35.1 g (1.95 mol) water were capped and sealed well with electrical tapes. The 3 bottles were taken out of the drybox and placed on a roller set at 80 rpm to roll for 2 hours. After 2 hours, the 3 bottles were brought back into the drybox.
2. 760 g of dry heptane (3A molecular sieves overnight) was charged into the 4L reactor equipped with an anchor stir blade. The Lauda chiller was turned on with the temperature controller set at −30° C. The stirrer was turned on and set to 170 rpm.
3. After the isohexane was cooled to −1° C., the filtration cap at the reactor bottom was checked to ensure no leaking, 184.2 g (2.55 mol) of neat TMA was added to the reactor. The TMA:water ratio is 2.55:1.95 or 1.31:1.
4. While waiting for the TMA solution to reach −15° C., 1 of the 3 bottles of water absorbed silica slurry was transferred to the 600 mL reactor and cooled to about −5° C. and stirred to ensure a good mixing.
5. After the TMA solution temperature reach −15° C., started the addition of the water absorbed silica in a rate that maintained the reaction temperature between −9° C. to −12° C. under 250 rpm.
6. After the addition of silica slurry, the agitation was adjusted to 170 rpm, the jacket temperature was increased to 1° C. and maintained for 30 minutes and then to ambient.
7. The slurry was then heated by setting the heater to 96° C. to allow the reaction temperature to be 92° C.-93° C. and maintained for 5 hours.
8. The reaction temperature was reduced to ambient. The agitation was stopped to allow the solid to settle. An ¹H-NMR spectrum was acquired for the supernate in THF-d8 (deuterated tetrahydrofuran) and showed 270 ppm TMA.
9. The stirrer was turned back on and set at 170 rpm, 8.63 g M3 catalyst precursor compound was added at once and the slurry was stirred for 2 hours.
10. The slurry was then filtered, washed with 2x 1L isohexane, and dried overnight under vacuum at ambient. Yield: 471.5 g. The catalyst was tested for gas-phase ethylene polymerization in a 2L autoclave salt-bed reactor with procedure described in Example 21.

Examples 6-21 (Preparation of finished catalysts from silica with different calcinated temperature and water content and from M1 and M2 metallocenes)

Example 6-15, 17-21 finished catalysts were prepared with procedures similar to Example 5, and Example 16 similar to Example 1, with variations in Table 3:

TABLE 3
Preparation of Finished Catalysts for Examples 6-21

| | Silica | | | | | | sMAO | sMAO | | |
|---|---|---|---|---|---|---|---|---|---|---|
| | (Calc. | Silica | | | Solvent | Solvent | Forming | Heating | | Metallocene |
| EX | Temp, | Amount | H₂O | TMA | for silica | for TMA | Temp. | Temp. | Yield | (Activity vs. |
| # | ° C.) | (g) | g/(mmol/g silica) | | (g) | (g) | (° C.) | (° C./hr) | (g) | standard¹) |
| 6 | ES70X | 300 | 27.0/ | 162.2 | iC6 | iC6 | −10 | 59/3 | 416 | M2 |
| | (200) | | (5.0) | (7.5) | 1080 | 758 | | | | 100% |
| 7 | ES70X | 300 | 27.0/ | 162.2 | iC6 | iC6 | −10 | 59/3 | 411 | M2 |
| | (200) | | (5.0) | (7.5) | 1080 | 758 | | | | 86% |
| 8 | ES70X | 360 | 30.46/ | 176.9 | iC6 | iC6 | −10 | 58/3 | 508 | M1 |
| | (200) | | (4.7) | (6.8) | 1296 | 1314 | | | | 100% |
| 9 | ES70X | 360 | 30.46/ | 176.9 | iC6 | iC6 | −10 | 58/3 | 501 | M1 |
| | (200) | | (4.7) | (6.8) | 1296 | 1314 | | | | 124% |
| 10 | ES70X | 50 | 4.5/ | 25.7 | iC6 | iC6 | −10 | 58/3 | 67 | M2 |
| | (200) | | (5.0) | (7.1) | 180 | 700 | | | | 117% |
| 11 | ES70X | 300 | 27.0/ | 154.0 | iC6 | iC6 | −12 | 58/3 | 439 | M1 |
| | (200) | | (5.0) | (7.1) | 1059² | 1336 | | | | 140% |
| 12 | DM-L | 300 | 25.94/ | 147.4/ | Heptane | Heptane | −14 | 92/4 | 404 | — |
| | 403 | | (4.8) | (6.8) | 1080 | 600 | | | | |
| | (200) | | | | | | | | | |
| 13 | ES70X | 400 | 34.56/ | 196.6/ | Heptane | Heptane | −10 | 85/4 | 560 | M2 160% |
| | (200) | | (4.8) | (6.8) | 1440 | 900 | | | | |
| 14 | ES70X | 300 | 27.0/ | 161.2/ | iC6 | iC6 | −10 | 60/3 | 441 | M1 134% |
| | (200) | | (5.0) | (7.5) | 1080 | 1336 | | | | |
| 15 | ES70 | 50 | 5.40/ | 28.6/ | Heptane | Hpetane | −5 | 85/4 | 70 | M3 10% |
| | (875) | | (6.0) | (8.0) | 180 | 668 | | | | M2 42% |
| | | | | | | | | | | M1 49% |
| 16 | ES70 | 200 | 28.08/ | 180.0/ | iC6 | iC6 | −12 | 92/4 | 328 | M3 70% |
| | (400) | | (7.8) | (12.5) | 720 | 800 | | | | |
| 17 | ES70 | 50 | 8.2/ | 50.0/ | iC6 210 | iC6 | −20 | 40/2 | 77 | M3 60% |
| | (875) | | (9.1) | (13.9) | Mineral | 1500 | | | | |
| | | | | | oil 400 | | | | | |
| 18 | ES70X | 40 | 3.10/ | 22.4/ | Heptane | Heptane | −20 | 92 | 52 | M1 100% |
| | (200) | | (4.3) | (7.8) | 144 | 655 | | | | |
| 19 | ES70X | 40 | 3.10/ | 157.5/ | Heptane | Heptane | −20 | 92 | 53 | M1 122% |
| | (200) | | (4.3) | (54.6) | 144 | 609 | | | | |
| 20 | ES70X | 40 | 3.10/ | 22.5/ | Heptane | Heptane | −10 | 92 | 52 | M1 95% |
| | (200) | | (4.3) | (7.8) | 144 | 640 | | | | |
| 21 | ES70X | 40 | 3.10/ | 157.5/ | Heptane | Heptane | −10 | 92 | 52 | M1 136% |
| | (200) | | (4.3) | (54.6) | 144 | 640 | | | | |

¹Standard catalysts are M1, M2, and M3 metallocenes supported on the same silica derived supported regular MAO (W. R. Grace 30% MAO solution in toluene) with MAO loading of 6.2 mmol Al/g silica, to give activities of 2,912, 3,389, and 6,294 g/g cat/hr, respectively;
²Silica and water were charged in a 2 L round bottom flask and sealed well with a rubber septum and electrical tapes; the round bottom flask was placed in a balance to record the weight before it was place in an oven set at 55° C. to heat for 5 hr; the flask was taken out of the oven and cooled to ambient and weighted again to make sure no significant weight loss before the solvent was added and mixed well; the slurry was then added to the 600 mL jacketed reactor as 3 equal portions.

### Example 22 (Polymerization Tests)

A lab scale 2L salt-bed gas-phase polymerization reactor, in which a 2L autoclave reactor was heated to 110° C. and purged with N₂ for at least 30 minutes. It was charged with dry NaCl (350 g; Fisher, S271-10 dehydrated at 180° C. and subjected to pump/purge cycles and finally passed through a 16 mesh screen prior to use) and TIBAL treated silica (5 g at 105° C.) and stirred for 30 minutes. The temperature was adjusted to 85° C. At a pressure of 2 psig N₂, dry and degassed 1-hexene (C₆-, see Table 4 for different volumes for different catalysts) was added to the reactor with a syringe and then the reactor was charged with N₂ to a pressure of 20 psig. A mixture of H₂ and N₂ was flowed into the reactor (See Table 4 for pre-charge 1H₂; 10% H₂ in N₂ in use) while stirring the bed. Catalysts indicated in the Table 4 below were injected into the reactor with ethylene (C₂) at a pressure of 220 psig. C₂ was allowed to flow over the course of the run to maintain constant pressure in the reactor. C₆ was fed into the reactor as a ratio to ethylene as indicated in Table 4. H₂ was fed to the reactor at a ratio to C₂ as indicated in Table 4. The H₂ and C₂ ratios were measured by on-line GC analysis. Polymerizations were halted after 1 hour by venting the reactor, cooling to about 23° C., and exposing the reactor to air. The salt was removed by washing with water two times. The polymer was isolated by filtration, briefly washed with acetone, and dried in air for at least for two days. Catalyst activities are reported in the Table 2 above.

TABLE 4
2 L Salt-Bed Reactor for Gas-Phase Ethylene
(C2⁼)-Hexene (C6⁼) Copolymerization

| | H₂ Pre- | H₂/C2⁼ | C6⁼ Pre- | C6⁼/C2⁼ | Catalyst |
|---|---|---|---|---|---|
| | charge | flow | charge | flow | Charge |
| Metallocene | (mL) | (mol/mol) | (mL) | (mol/mol) | (mg) |
| M1 | 85 | 0.25 | 1.5 | 0.06 | 20 |
| M2 | 85 | 0.25 | 1.5 | 0.06 | 20 |
| M3 | 120 | 0.50 | 2.5 | 0.10 | 12 |

### Example 23 (H¹—NMR Method for Quantification of TMA Content in Supemate)

Into a 5 mm NMR tube are charged about 0.5 inch of the supernate of interest and about 1 inch of THF-d8. The mixture is mixed well. An H¹ NMR spectrum is required on a Brucker 400 MHz instrument using ns=8 and D1=Is. The solvent peaks including CH₃, CH₂, and CH₁ signals (˜0.3 ppm to ˜2.5 ppm area including THF-d8 1.73 ppm peak (too small, no subtraction)) and TMA (sharp singlet peak in between ˜0.9 to ˜1.0 ppm) are integrated and the solvent integral is set to 1400 (for iC6, 14H) or 1600 (for heptane, 16H). If the integral of TMA is x, the TMA concentration y can be calculated as:

$$\begin{matrix}y = ( 72.1 * x / 9 ) / ( 72.1 * x / 9 + 86.2 * 100 ) for iC 6 as solvent \\ y = ( 72.1 * x / 9 ) / ( 72.1 * x / 9 + 100.2 * 100 ) for heptane as solvent .\end{matrix}$$

For example, Example 3 shows no TMA detected whereas Example 4 shows detected TMA with integral 0.21; the concentrationy in heptane is therefore:

$$y = 72.1 * 0.21 / 9 / ( 72.1 * 0.21 / 9 + 100.2 * 100 ) = 0.000168 or 168 ppm .$$

The Figure provides a spectrum showing the TMA for Examples 3 and 4.

### Example 24 (Standard Catalyst Preparation from Supported Regular MAO)

10.0 g ES70X (600° C. calcination) or ES70 (875° C. calcination) silica was added in a 100 mL cel-stir reactor with 40 g toluene. To this slurry was slowly added MAO (30% toluene solution from W. R. Grace) 12.4 g (62.0 mmol Al based on Al in MAO solution 13.5 wt % or 5.0 mmol/g) at ambient. After the MAO addition, the mixture was stirred at ambient for 1 hour.

The solid supported MAO was isolated by filtering through a frit, washing with 2x 40 g iC6, and drying under vacuum for 2 hours. Yield: 13.9g.

M1 finished catalyst (sMAO on ES70X (600° C.)): 2.0 g sMAO from above procedure was charged in a 20 mL vial, following by 8 g toluene. 35 mg (40 mol/g sMAO) M1 was mixed with the slurry, which was shaken on a shaker for 1 hour. The solid supported catalyst was isolated by filtering through a frit, washing with 2x 10 g iC6, and drying under vacuum for 1 hour. Yield: 2.0g.

M2 finished catalyst (sMAO on ES70X (600° C.)): 2.0 g sMAO from above procedure was charged in a 20 mL vial, following by 8 g toluene. 33 mg (35 mol/g sMAO) M2 was mixed with the slurry, which was shaken on a shaker for 1 hour. The solid supported catalyst was isolated by filtering through a frit, washing with 2x 10 g iC6, and drying under vacuum for 1 hour. Yield: 2.0 g.

M3 finished catalyst (sMAO on ES70 (875° C.)): 2.0 g sMAO from above procedure was charged in a 20 mL vial, following by 8 g toluene. 38 mg (45 mol/g sMAO) M3 was mixed with the slurry, which was shaken on a shaker for 1 hour. The solid supported catalyst was isolated by filtering through a frit, washing with 2x 10 g iC6, and drying under vacuum for 1 hour. Yield: 2.0 g.

All documents described herein are incorporated by reference herein, including any priority documents and/or testing procedures to the extent they are not inconsistent with this text. As is apparent from the foregoing general description and the specific embodiments, while some embodiments have been illustrated and described, various modifications can be made without departing from the spirit and scope of the disclosure. Accordingly, it is not intended that the disclosure be limited thereby. Likewise, the term “comprising” is considered synonymous with the term “including.” Likewise, whenever a composition, an element or a group of elements is preceded with the transitional phrase “comprising”, it is understood that we also contemplate the same composition or group of elements with transitional phrases “consisting essentially of,” “consisting of”, “selected from the group of consisting of,” or “is” preceding the recitation of the composition, element, or elements and vice versa.

We claim:

1. A method for preparing a catalyst system comprising:
contacting in an organic solvent at least one support material having absorbed water and trimethylaluminum (TMA) to form a supported MAO (catalyst precursor) in-situ; and
contacting the supported MAO with at least one catalyst precursor compound having a Group 3 through Group 12 metal atom or lanthanide metal atom, wherein the charged TMA to water ratio and the in-situ sMAO formation temperature are so controlled that the supernate after the in-situ supported MAO formation with optional heating or after the finished catalyst formation contains no detectable TMA or not more than 600 ppm TMA, provided that,
a. for a support containing absorbed water 6.5 (mmol/g support) or less, the charged TMA:water ratio is controlled in the range of between 1.31:1 and 1.25:1 and the in-situ supported MAO formation temperature is controlled at between −8° C. and −60° C.,
b. for a support containing absorbed water 5.0 (mmol/g support) or less, the charged TMA:water ratio is controlled in the range of between 1.42:1 and 1.25:1 and the in-situ supported MAO formation temperature is controlled at between −8° C. to −60° C., and
c. for a support containing absorbed water 7.0-10.0 (mmol/g support), the charged TMA:water ratio is controlled in the range of between 1.20:1 and 1.15:1 and the in-situ sMAO formation temperature is controlled at between −12° C. and −60° C.

2. A method for preparing a catalyst system comprising:
contacting in an organic solvent at least one support material having absorbed water and trimethylaluminum (TMA) to form a supported MAO (catalyst precursor) in-situ;
contacting the supported MAO with at least one catalyst precursor compound having a Group 3 through Group 12 metal atom or lanthanide metal atom,
wherein TMA to water ratio is in between 1.80:1 to 1.42:1 and the in-situ supported MAO formation temperature is between −6° C. to −60° C.; and
recovering free TMA from a supemate, after the in-situ supported MAO formation or after finished catalyst formation is removed, by adding, to the supernate, a second support containing hydroxyl groups to result in no detectable or not higher than 600 ppm TMA in the supemate.

3. The method of claim 2, wherein the second support containing the hydroxyl groups are water absorbed silica the same as or different from the one used in making the in-situ sMAO or the derived finished catalyst.

4. The method of claim 2, wherein the support containing hydroxyl groups are silica calcined at 150° C. to 875° C.

5. The method of one of claims 1 to 4, wherein the at least one catalyst precursor compound having a Group 3 through Group 12 metal atom or lanthanide metal atom comprises at least one substituted or non-substituted cycplopentadienyl ligand to form a bridging or unbridging half-metallocene or metallocene.

6. The method of one of claims 1 to 4, wherein the at least one catalyst precursor compound having a Group 3 through Group 12 metal atom or lanthanide metal atom comprises at least one organic ligand with at least two hetero-atom donors.

7. The method of claim 6, wherein the at least one organic ligand with at least two hetero-atom donors comprises oxygen, nitrogen, or phosphorus donors.

8. A method of producing a polyolefin product, comprising polymerizing an olefin by contacting the olefin with the catalyst system produced from one of claims 1-6.
